(19) United States
(12) Patent Application Publication
(10) Pub. No.: US 2026/0076510 A1
(43) Pub. Date: Mar. 19, 2026

(54) IN-VEHICLE FOOD PRODUCT HOLDING SYSTEM

(71) Applicant: CFA Properties, Inc., Atlanta, GA (US)

(72) Inventors: Joel Eric Tetreault, Roswell, GA (US); Francis Xavier Librojo Garing, Atlanta, GA (US); Sophia Cara De Lurgio, Atlanta, GA (US); David Stonewall Shaltanis, Atlanta, GA (US); Philip D. Palermo, Marietta, GA (US); Russell Joseph Kroll, Atlanta, GA (US)

(21) Appl. No.: 19/332,918

(22) Filed: Sep. 18, 2025

Related U.S. Application Data
(60) Provisional application No. 63/696,559, filed on Sep. 19, 2024.

(51) Int. Cl. A47J 41/00; B60R 7/02

(52) U.S. Cl. CPC A47J 41/005; B60R 7/02

(57) ABSTRACT

Embodiments of the present disclosure relate to a system and method for holding food products within a vehicle. An example system includes a basin configured to receive food products and comprising at least one channel. The at least one channel may be configured to receive at least one divider to segment the basin into at least a first chamber and a second chamber. The system may further include a door configured to transition between a first state and a second state to expose the basin. The system may further include at least one environment regulation system configured to actively control at least one environmental condition within at least one of the chambers.

### CROSS REFERENCE TO RELATED APPLICATIONS

This application claims the benefit of and priority to U.S. Application No. 63/696,559, filed Sep. 19, 2024, entitled “IN-VEHICLE FOOD PRODUCT HOLDING SYSTEM,” the disclosure of which is incorporated herein by reference in its entirety.

### TECHNICAL FIELD

This application generally relates to systems for holding and transporting food products.

### BACKGROUND

Generally, food delivery includes obtaining food products from a quick-service restaurant (QSR) or other venue and transporting the food products by vehicle to one or more delivery destinations. For example, food products may be packaged into paper or plastic bags, which are subsequently collected by a delivery person and placed into a vehicle for transportation. In historical approaches, the bags are often placed directly into a passenger seat or trunk of a car, thereby exposing the food products to the external environment for the duration of transportation. As a result, food products may be delivered outside of a target temperature range. For example, hot items may cool to room temperature and cold items may melt during delivery. In addition, the bags are typically not secured to the car and may spill or tip or fall off of a seat as the car is driven.

Other approaches include placing food products into an insulated container, such as a foam- or thermal-foil lined bag. The insulated containers may reduce the rate of change in food product temperature; however, such passive techniques may still fail to preserve food products within their target serving temperatures. Also, such approaches may fail to insulate the food products from humid conditions that undesirably transform the texture of the food products (e.g., resulting in soggy food consistencies). Further, the containers themselves may experience large deviations in temperature over the course of a delivery day, which may reduce their effectiveness in insulating food products over time. In addition, a delivery person may have to decide between placing cold or hot items into an insulated container, resulting in the excluded item falling outside of a target serving temperature.

For these reasons, among others, the historical food product transportation systems demonstrate drawbacks in temperature regulation and efficient spatial organization. Thus, QSRs and delivery services have not yet solved the challenges of preserving food product quality during delivery.

### SUMMARY

Embodiments of the present disclosure relate to apparatuses, devices, systems, and methods for holding food products. An example system for holding food products may include a basin configured to receive food products and comprising at least one mating surface. The at least one mating surface may be configured to receive at least one engagement surface of at least one divider to segment the basin into at least a first chamber and a second chamber. The system may further comprise a door configured to transition between a first state and a second state to expose at least a portion of the basin. The system may further comprise at least one environment regulation system configured to actively control at least one environmental condition within at least one of the chambers.

In some embodiments, the door is configured to slide horizontally from the first state to the second state to simultaneously expose all chambers of the basin. In some embodiments, the at least one environment regulation system comprises a heating system configured to maintain a hot climate within the first chamber. In some embodiments, the heating system comprises a positive temperature coefficient air heater. In some embodiments, the at least one environment regulation system comprises a cooling system configured to maintain a cold climate within the second chamber. In some embodiments, the cooling system comprises a compressor-based refrigeration module.

In some embodiments, the basin comprises a grated panel configured to provide a vertical offset between the food products and a bottom surface of the basin. In some embodiments, at least one of the first chamber or the second chamber comprises at least one cupholder; and the at least one cupholder is configured to transition between a stowed configuration and a deployed configuration. In some embodiments, the basin comprises an external rail configured to receive at least one accessory module. In some embodiments, the at least one mating surface comprises at least three mating surfaces spaced apart from another along the basin. In some embodiments, the system further comprises at least one attachment element configured to secure the basin to a vehicle. In some embodiments, the food product holding system is configured to receive power from the vehicle.

In another example, an example system for holding food products may include a basin configured to receive food products and comprising a first channel, a second channel, and a third channel. The system may further include a first divider configured to be inserted into the first channel and a second divider configured to be inserted into the second channel to compartmentalize the basin into a first chamber, a second chamber, and a third chamber. The system may further include a door configured to transition between a closed state and an open state to expose at least a portion of the basin. The system may further include a heating system configured to maintain a hot climate within the first chamber. The system may further include a cooling system configured to maintain a cold climate within the third chamber. The system may further include a humidity control system configured to control humidity levels within the second chamber.

In some embodiments, a portion of a bottom surface of the basin associated with the third chamber comprises an evaporator plate configured to transfer heat from the third chamber to a refrigerant of the cooling system. In some embodiments, the humidity control system is configured to regulate airflows between the first chamber, second chamber, and third chamber to control humidity levels within the second chamber. In some embodiments, the first divider and the second divider comprise at least one insulative material configured to minimize thermal transfer between chambers. In some embodiments, the system further comprises at least one subdivider configured to translate along a channel within the first chamber to segment the first chamber.

In some embodiments, the system further comprises a first relative humidity and temperature sensor configured to measure temperature and humidity levels within the first chamber and a second relative humidity and temperature sensor configured to measure temperature and humidity levels within the third chamber. In some embodiments, the system further comprises a first display configured to render temperature and humidity measurements of the first chamber and a second display configured to render temperature and humidity measurements of the third chamber.

In various embodiments, a method of maintaining food product quality during vehicle-based delivery is provided herein. For example, a method of maintaining food product quality during vehicle-based delivery may include inserting at least one divider into a basin to compartmentalize the basin into a plurality of chambers via interface of at least one engagement surface of the at least one divider with at least one mating surface of the basin. The method may further include placing hot-serve food products into a first chamber and cold-serve food products into a second chamber. The method may further include actively heating the first chamber to maintain the hot-serve food products within a target temperature range. The method may further include actively cooling the second chamber to maintain the cold-serve food products within a target temperature range.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 shows a perspective view of an example carrying system in accordance with some embodiments of the present disclosure;

FIG. 2 shows a top view of an example holding system in accordance with some embodiments of the present disclosure;

FIG. 3A shows a front view of an example holding system in accordance with some embodiments of the present disclosure;

FIG. 3B shows a back view of an example holding system in accordance with some embodiments of the present disclosure;

FIG. 4A shows a left-side view of an example holding system in accordance with some embodiments of the present disclosure;

FIG. 4B shows a right-side view of an example holding system in accordance with some embodiments of the present disclosure;

FIG. 4C shows a bottom view of an example holding system in accordance with some embodiments of the present disclosure;

FIG. 5 shows a perspective view of a portion of an example holding system in accordance with some embodiments of the present disclosure;

FIG. 6 shows a top view of a portion of an example holding system in accordance with some embodiments of the present disclosure;

FIG. 7 shows a perspective view of a portion of an example holding system in accordance with some embodiments of the present disclosure;

FIG. 8 shows a perspective view of a portion of an example holding system in accordance with some embodiments of the present disclosure;

FIG. 9 shows a perspective view of a portion of an example holding system in accordance with some embodiments of the present disclosure;

FIG. 10A shows an example carrying system and holding system configured in accordance with some embodiments of the present disclosure;

FIG. 10B shows an example carrying system and holding system configured in accordance with some embodiments of the present disclosure;

FIG. 11 shows an example loading sequence of a holding system in accordance with some embodiments of the present disclosure;

FIG. 12 shows an example loading sequence of a holding system in accordance with some embodiments of the present disclosure;

FIG. 13 shows example bi-directional lids of a holding system configured in accordance with some embodiments of the present disclosure;

FIG. 14 shows a partial perspective view of a portion of a holding system in accordance with some embodiments of the present disclosure;

FIG. 15 shows example configurations of a holding system in accordance with some embodiments of the disclosure;

FIG. 16 shows a perspective view of a holding system in accordance with some embodiments of the present disclosure;

FIG. 17 shows a system architecture of a holding system and vehicle in accordance with some embodiments of the disclosure;

FIG. 18 shows a perspective view of an example carrying system in accordance with some embodiments of the present disclosure;

FIG. 19A shows a left-side view of an example carrying system in accordance with some embodiments of the present disclosure;

FIG. 19B shows a right-side view of an example carrying system in accordance with some embodiments of the present disclosure;

FIG. 20A shows a top view of an example carrying system in accordance with some embodiments of the present disclosure;

FIG. 20B shows a bottom view of an example carrying system in accordance with some embodiments of the present disclosure;

FIG. 21A shows a front view of an example carrying system in accordance with some embodiments of the present disclosure;

FIG. 21B shows a back view of an example carrying system in accordance with some embodiments of the present disclosure;

FIG. 22A an example loading arrangement of a carrying system in accordance with some example embodiments of the present disclosure;

FIG. 22B an example loading arrangement of a carrying system in accordance with some example embodiments of the present disclosure;

FIG. 23 shows an exemplary chamber reconfiguration of the carrying system in accordance with some example embodiments of the present disclosure;

FIG. 24 shows a perspective view of a holding system in accordance with some embodiments of the present disclosure;

FIG. 25 shows a perspective view of a holding system positioned within a vehicle in accordance with some embodiments of the present disclosure;

FIG. 26A shows a perspective view of an example holding system in accordance with some embodiments of the present disclosure;

FIG. 26B shows a top view of an example holding system in accordance with some embodiments of the present disclosure;

FIG. 26C shows a front view of an example holding system in accordance with some embodiments of the present disclosure;

FIG. 26D shows a back view of an example holding system in accordance with some embodiments of the present disclosure;

FIG. 27A shows a right side view of an example holding system in accordance with some embodiments of the present disclosure;

FIG. 27B shows a left side view of an example holding system in accordance with some embodiments of the present disclosure;

FIG. 27C shows a bottom view of an example holding system in accordance with some embodiments of the present disclosure;

FIG. 28A shows a top view of an example holding system demonstrating chamber compartmentalization in accordance with some embodiments of the present disclosure;

FIG. 28B shows a perspective view of an example holding system with reconfigured chamber dimensions in accordance with some embodiments of the present disclosure;

FIG. 28C shows a top view of an example holding system with multiple dividers in accordance with some embodiments of the present disclosure; and

FIG. 28D shows a perspective view of an example holding system illustrating internal configuration in accordance with some embodiments of the present disclosure.

### DESCRIPTION

In general, various embodiments of the present disclosure provide improved systems for maintaining quality of food products during delivery. As used herein, “food product” refers to any consumable product including beverages and the like. For example, a food product may include fries, sandwiches, tenders, nuggets, milkshakes, sodas, teas, and/or the like.

Historical approaches to delivering food commonly use insulation containers that sheath a food product against the external environment. For example, a paper bag may be filled with food products and placed into a soft-bodied bag having an interior liner comprised of insulative foam. However, such approaches introduce several drawbacks to ensuring food product quality remains with target ranges over the course of delivery. For example, the soft-bodied containers of previous approaches may render food products vulnerable to shocks, vibrations, and shifting throughout the delivery journey. As a result, food products may be crushed, spilled, or breached during delivery.

As another drawback, the temperature regulation techniques of previous approaches are typically passive in nature and, as a result, may be incapable of adequately preserving a food product within a target temperature range. For example, the effectiveness of temperature regulation of insulated bags may be significantly impacted by delivery duration and the temperature and humidity conditions inside and outside the delivery vehicle. Further, the passivity of such techniques may render previous approaches incapable of actively correcting for deviations in food temperature and moisture level. For example, a typical insulated container lacks any active means for generating and applying a corrective temperature gradient to a food product (e.g., fries cannot be actively heated, beverages cannot be actively cooled). As a result, food products may experience a continuous deviation from target temperature over the delivery journey.

Additionally, historical approaches may require a delivery person to combine hot-serve and cold-serve food products in the same container or decide between insulating hot-serve products or cold-serve products, exclusively. In the first scenario, the mixing of hot-serve and cold-serve food products may result in thermal exchanges that causes food products of both types to fall outside of target temperature ranges. In the second scenario, the excluded food products may be exposed to the external environment and, as a result, fall outside of a target temperature range.

To overcome these challenges, and others, the present disclosure provides an improved holding system that insulates food products from an external environment and comprises configurable, climate-controlled chambers for storing food products during a delivery journey. The holding system may be installed within a vehicle and configured to receive and preserve food products at desired temperatures, moisture levels, and/or the like throughout delivery operations. In various embodiments, the holding system includes a basin configured for dynamic compartmentalization via channel and divider arrangements. For example, the basin may be segmented into a plurality of chambers via insertion of a divider into one or more channels. The respective environments of the chambers may be insulated and independent from one another and an external environment. In this manner, chambers may be configured to accommodate food products having different target temperature ranges. For example, the holding system may comprise cold-serve chambers, hot-serve chambers, ambient-serve chambers, and/or the like. In some embodiments, the holding system includes one or more environment regulation systems that actively control temperature, humidity, and/or the like within a chamber. For example, the holding system may include powered cooling systems, heating systems, humidity control systems, and/or the like that maintain target conditions within a chamber. In doing so, the holding system may generate and apply different temperature gradients to maintain food products within target temperature ranges. As a result, the holding system may improve the quality of delivered food products and increase delivery throughput and efficiency. These advantages, and others, shall be made further apparent in the proceeding description of example embodiments of the holding system and the illustrations thereof provided in the accompanying figures.

### Example Holding System

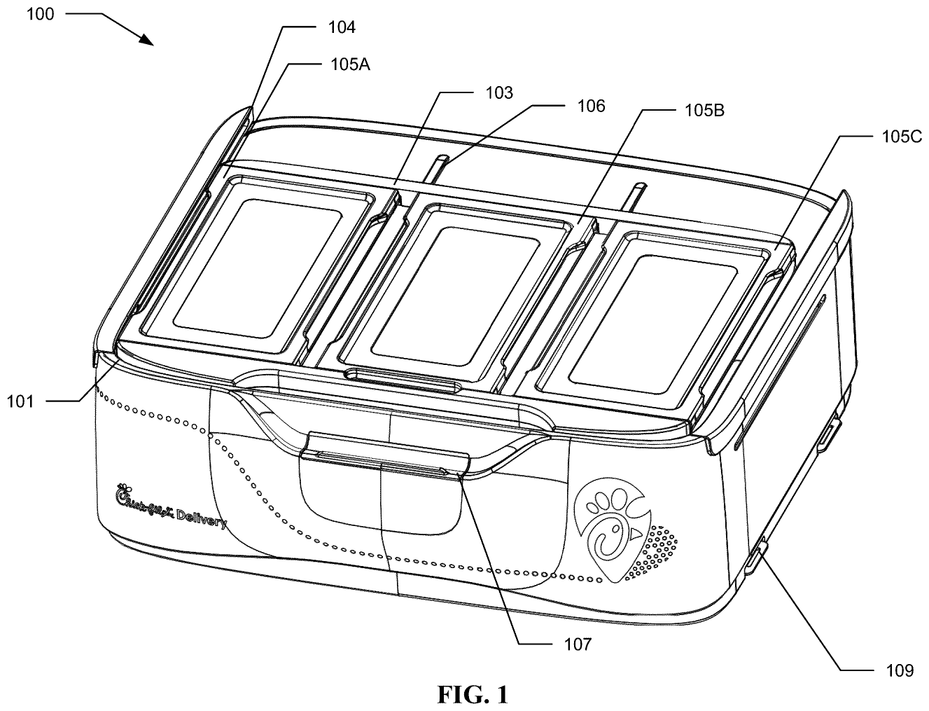

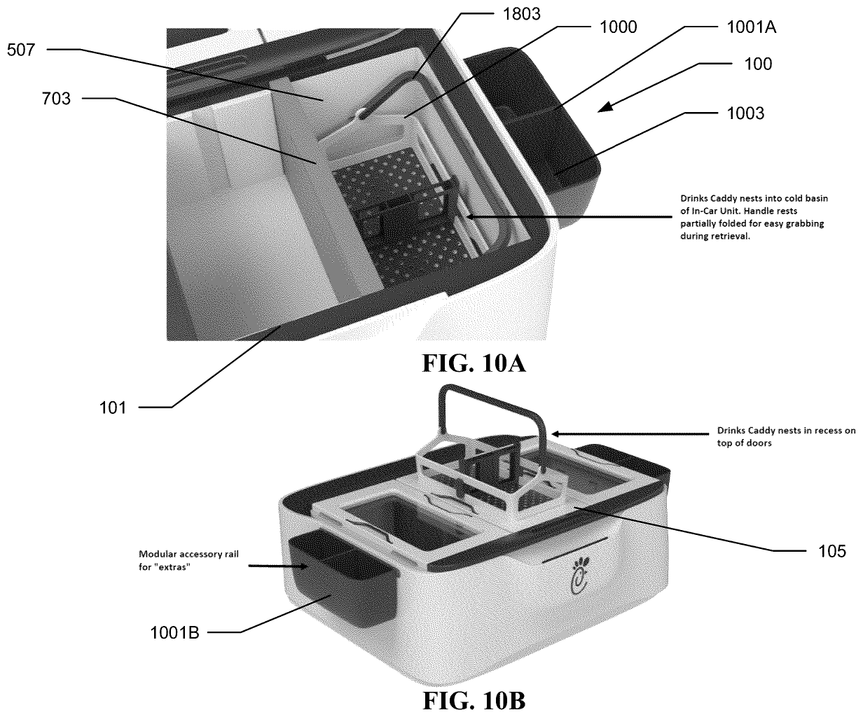

FIG. 1, shows a perspective view of an example holding system 100. In various embodiments, the holding system 100 is configured to receive and house food products during delivery operations. For example, a plurality of food products embodying one or more delivery orders may be placed within the holding system 100. The holding system 100 may insulate the food products from external conditions and actively regulate internal conditions within its interior volume to ensure food products remain within target temperature ranges as a delivery person performs the delivery. Additionally, in some embodiments, the holding system 100 is configured to receive and house carrying systems, which may comprise food products. For example, as shown in FIG. 10A, the holding system 100 may house one or more carrying systems 1000. Further, as shown in FIG. 10B, the holding system 100 may be configured as a staging platform for accommodating a carrying system 1000. In such contexts, a top surface of a lid 105A, 105B, 105C may comprise a rim of dimensions that conform to a footprint of the carrying system 100.

In some embodiments, the holding system 100 comprises or is used in association with one or more food transportation systems, humidity control systems, heat preservation systems, and/or the like as described in U.S. Pat. No. 12,011,022, filed Dec. 12, 2020, entitled “FOOD TRANSPORTATION AND HUMIDITY CONTROL ELEMENTS,” U.S. Pat. No. 11,604,027, filed Jun. 21, 2019, entitled “MODULAR HUMIDITY CONTROL AND HEAT PRESERVATION SYSTEM,” U.S. Pat. No. 11,918,153, filed Dec. 12, 2023, entitled “FOOD TRANSPORTATION AND HUMIDITY CONTROL ELEMENTS,” and/or the like, the disclosures of which are incorporated herein by reference in their entirety. For example, one or more food transportation systems and/or the like disclosed in the referenced patents may be provided in a vehicle along with the holding system 100. A delivery person may place food products within the holding system 100 while navigating the vehicle to a delivery destination. The delivery person may transfer the food products from the holding system 100 to into a food transportation system to complete a final leg of the delivery journey (e.g., door delivery, delivery within a building, and/or the like).

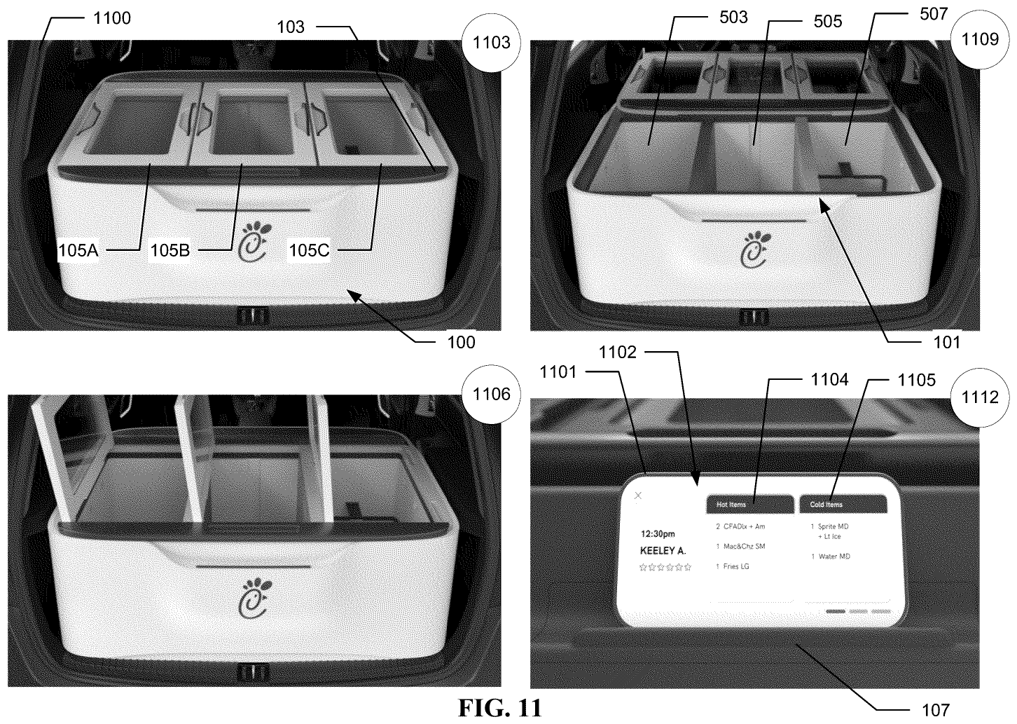

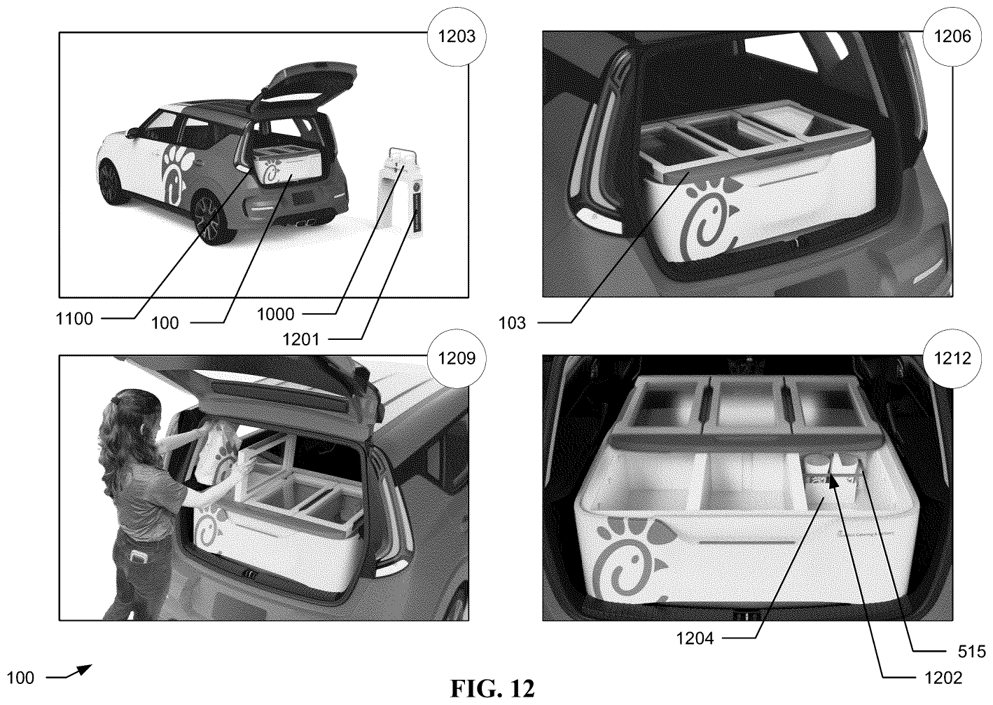

In some embodiments, the holding system 100 is configured to be installed within a vehicle. For example, as shown in FIGS. 11 and 12, the holding system 100 may be placed within a trunk portion of a vehicle. As another example, the holding system 100 may be placed in a passenger portion of a vehicle, such as on one or more passenger seats. In various embodiments, the holding system 100 includes a basin 101 and is configured to receive food products, carrying systems, and/or the like into an interior volume of the basin 101. For example, as shown in FIGS. 10A, 12, and 18, food products, packages containing food products, and carrying systems may be placed within the basin 101.

In some embodiments, the basin 101 includes a plurality of chambers for receiving food products, carrying systems, and/or the like. In various embodiments, a respective chamber is configured to maintain an environmental condition of hot, cold, humidity controlled, ambient, and/or the like. For example, the basin 101 may include a first chamber configured to maintain a high internal temperature, a second chamber configured to maintain an ambient and/or humidity-controlled chamber, and a third chamber configured to maintain cool or cold temperatures. The first chamber may be configured to receive food products associated with a hot serving temperature, such as fries, tenders, filets, nuggets, cookies, and/or the like. The second chamber may be configured to receive dipping sauces, dressings, potato chip packages, preserved fruit packages, and/or the like. The third chamber may be configured to receive beverages, frozen desserts, salads, and/or the like. The chambers may be environmentally isolated from one another by dividers such that temperature, humidity, and/or the like within a chamber may be independently configured and regulated relative to other chambers.

In some embodiments, the basin 101 includes one or more modular shelves. For example, the basin 101 may include one or more rails, channels, and/or the like configured to receive and support a shelf. A shelf may be horizontally and vertically reconfigurable within the basin 101. For example, the shelf may be moved from a first vertical position to a second vertical position. As another example, the shelf may be moved from a first horizontal position to a second horizontal position within a chamber or between chambers. In various embodiments, a shelf is configured to support a plurality of food products. For example, a shelf may be configured to receive and support a catering tray.

In various embodiments, the holding system 100 includes a door 103 configured to transition between a closed state and an open state to seal and expose an interior volume of the basin 101. For example, as shown in FIGS. 11 and 12, the door 103 may slide laterally to expose all chambers of the basin 101 simultaneously (see indicia 1109 and 1212, respectively). In some embodiments, the holding system 100 includes slots 104 that receive opposing edges of the door 103. The slots 104 may enable the door 103 to slide between a closed state and an open state. In some embodiments, a slot 104 includes a notch, detent, magnetic clamp, and/or the like that prevents motion of the door 103 until sufficient force or mechanical engagement is applied by a user. In some embodiments, the holding system 100 includes one or more rails 106 along which the door 103 slides to transition between closed and open states.

In some embodiments, the holding system 100 includes one or more sensors configured to detect whether the door 103 is configured to a closed state or an open state. For example, the holding system 100 may include an optical sensor, magnetic sensor, pressure sensor, and/or the like that generates measurements indicative of the position of the door 103. In some embodiments, the holding system 100 outputs one or more effects in response to detecting transition of the door 103 from a closed state to an open state. For example, the holding system 100 may activate one or lighting elements, displays, and/or the like to indicate the door 103 is configured to the open state. The holding system 100 may include a first lighting element configured to emit red light within a hot chamber of the basin 101 (e.g., the hot chamber configured to receive hot-serve food products, such as fries, tenders, sandwiches, and/or the like). The holding system 100 may include a second lighting element configured to emit blue light within a cold chamber of the basin 101 (e.g., the cold chamber configured to receive cold-serve food products, such as beverages, desserts, salads, and/or the like).

Alternatively, or additionally, in some embodiments, the holding system 100 comprises one or more LED panels, LED strips, or other lighting elements positioned within or adjacent to the chambers to provide illumination of the interior volume. The interior light sources may be positioned along one or more walls of the chambers to ensure adequate visibility of food products placed within the basin 101. The interior lighting elements may facilitate efficient loading and unloading operations by enabling a delivery person to clearly view the contents of each chamber, particularly in low-light conditions such as during evening deliveries or when the holding system 100 is positioned within a dimly lit vehicle trunk. In some embodiments, the interior light sources are automatically activated in response to opening of the door 103 or individual lids, and may be deactivated when the door 103 or lids are returned to a closed state to conserve power.

In some embodiments, the holding system 100 is configured to activate one or more environment regulation systems based on the position of the door 103. For example, the holding system 100 may activate or deactivate one or more heating systems, cooling systems, humidity control systems, and/or the like in response to detecting a transition of the door 103 from the closed state to the open state, or vice versa. In doing so, the holding system 100 may conserve power consumption of the environment regulation systems or increase the output of the systems to better oppose conditions of the external environment. For example, in response to a user opening the door 103, the holding system 100 may automatically activate or deactivate a cooling fan in a first chamber and a heating element in a second chamber.

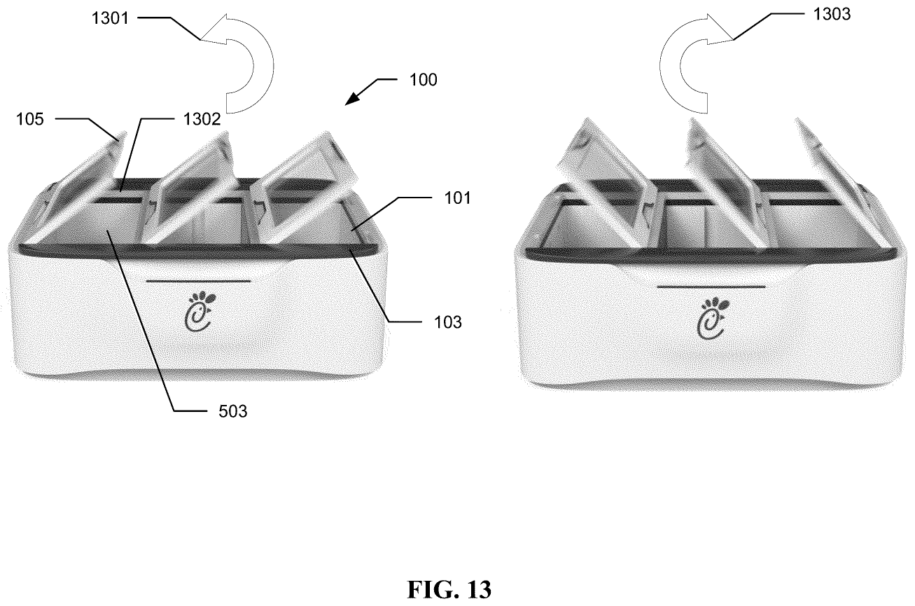

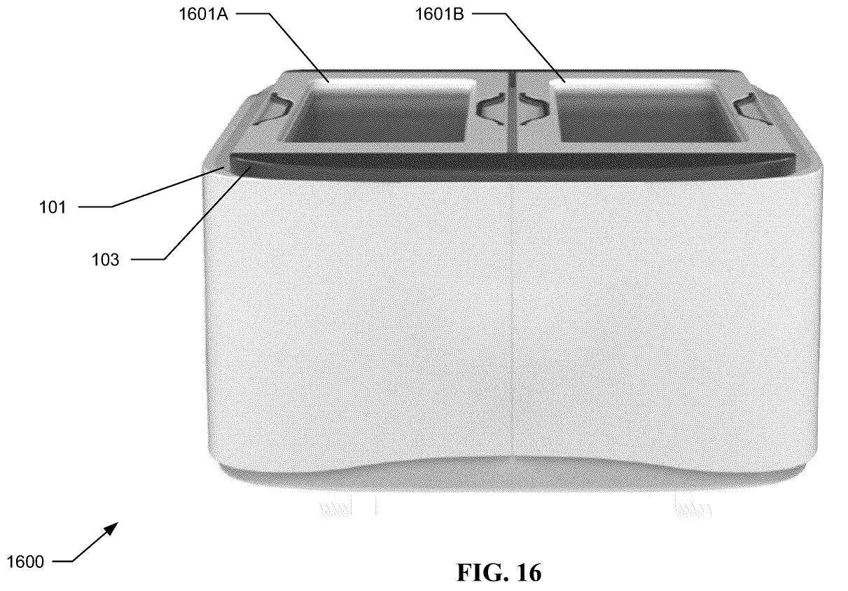

In some embodiments, the door 103 includes a plurality of lids configured to independently open and close to expose individual chambers of the basin 101. For example, the door 103 may include lids 105A, 105B, 105C that are each configured to transition between a closed state and an open state to seal or expose a chamber of the basin 101. The door 103 may include any suitable number of lids. For example, as shown in FIG. 1, the door 103 may include three lids 105A, 105B, 105C. As another example, as shown in FIG. 16, the door 103 may include two lids 105A, 105B. In some embodiments, a lid is configured to rotate bidirectionally to transition between a closed and opened states. For example, as shown in FIG. 13, a lid 105 may be rotated in a first direction 1301 (e.g., anticlockwise) or a second direction 1303 (e.g., clockwise) to expose a void 1302 within the door 103 such that a user may access an underlying chamber 503. In this manner, a lid may be rotated in either of two directions to expose a chamber within the basin 101. In some embodiments, the lid is removable from the door 103. For example, the hinges of the lid may be configured to enable a user to lift the lid vertically out of the door 103. In various embodiments, the bidirectional movement and removability of the lid improves efficiency of loading and unloading the holding system 100. For example, the lids of the holding system 100 may be agnostic as to a side from which a user lifts the lid, whereas other approaches may include unidirectional lids that require a user to first identify the appropriate side from which to lift a lid.

In some embodiments, the holding system 100 includes one or more device platforms 107 configured to accommodate a user's computing device. For example, a device platform 107 may comprise a concave section of the holding system 100. The device platform 107 may provide a stable surface onto which a smartphone, tablet, phablet, and/or the like may be placed. In some embodiments, the device platform 107 is in front of the basin 101 such that a computing device placed onto the device platform 107 is positioned in front of the basin 101. In this manner, the device platform 107 may enable a delivery person to view their computing device (e.g., having rendered thereon order contents, delivery instructions, and/or the like) while configuring and organizing food products within the chambers of the basin 101. In addition, the device platform 107 can also function as a grab handle for the holding system 100 such as when the holding system is positioned on a shelf inside a restaurant. The delivery person can use the device platform 107 to more easily pull the holding system 100 from the shelf.

In some embodiments, the holding system 100 includes one or more attachment elements 109 configured to receive a strap, fastener, and/or the like for securing the holding system 100 to a vehicle. For example, the attachment element 109 may include a loop through which a strap, snap-fitting, and/or the like may be inserted to anchor the holding system 100 within a trunk of a vehicle. In some embodiments, the attachment element 109 is configured to receive a seat strap, buckle, and/or the like. The attachment element 109 may be configured in embodiments to be compatible with the LATCH system's mounting points for child seats. In this manner, the holding system 100 may be stabilized relative to the vehicle. In various embodiments, the anchoring of the holding system 100 to the vehicle reduces a likelihood of food products becoming shifted, dislodged, or breached during transit. For example, approaches utilizing conventional soft body insulated bags may lack means for securing the bags against movement of the vehicle. As a result, such systems may render food products more vulnerable to shifting and breakage as a result of the accelerations and decelerations of the delivery vehicle. To overcome this challenge, the holding system 100 may be temporarily secured to the vehicle throughout the delivery journey.

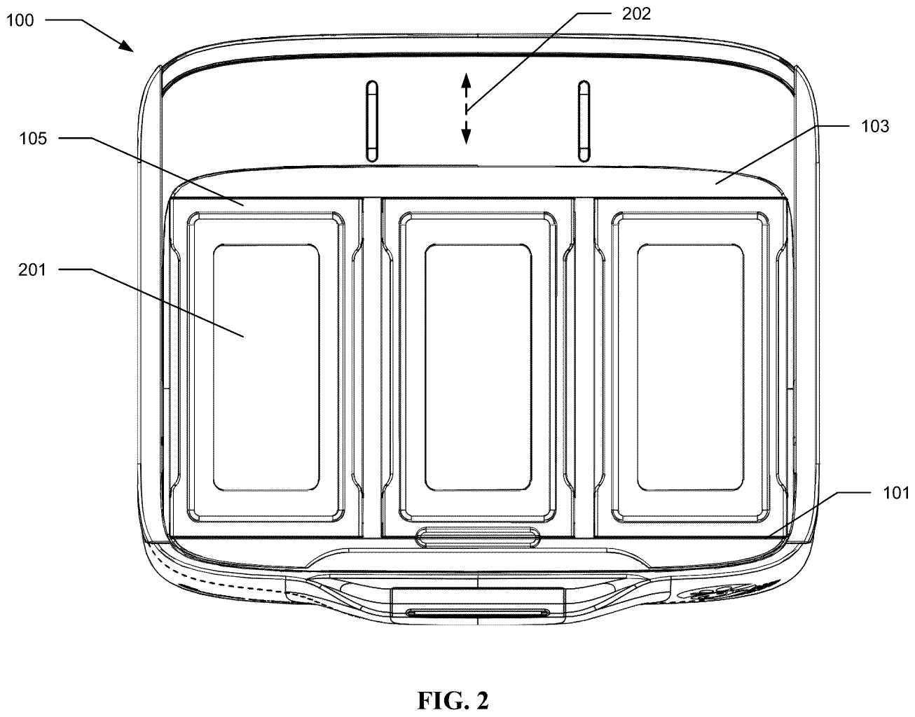

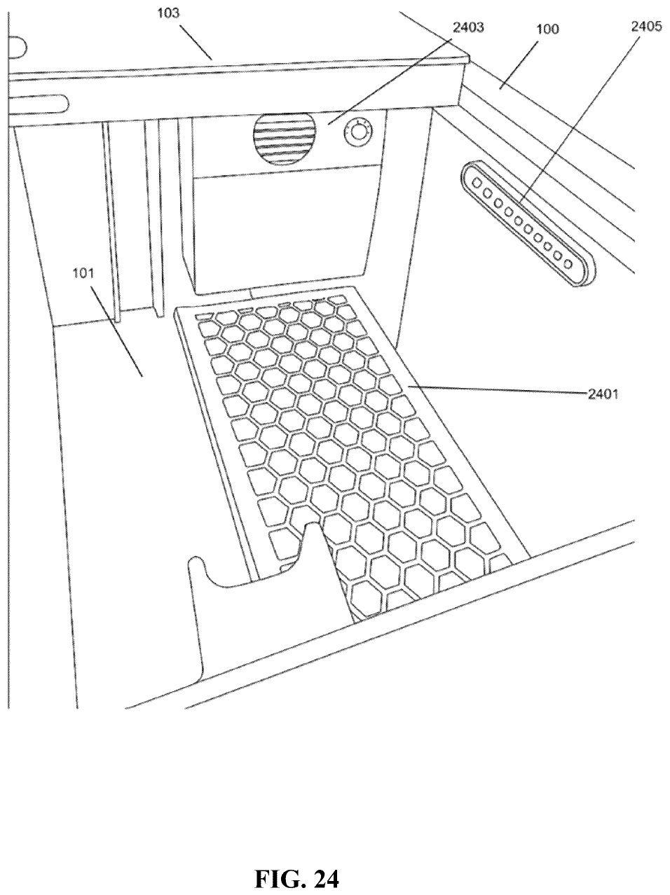

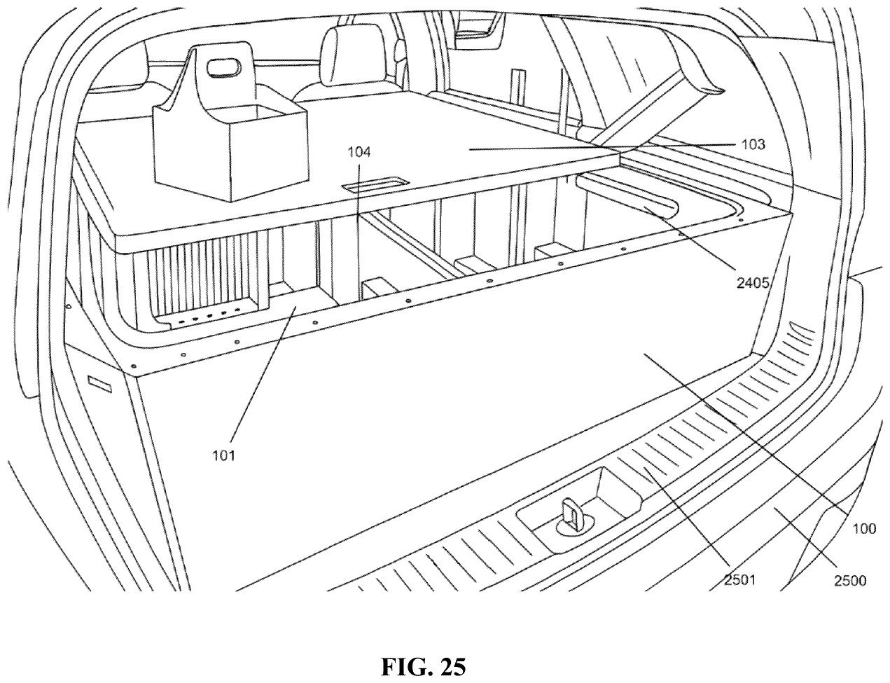

FIG. 2 shows a top view of the holding system 100. In various embodiments, the door 103 is configured to forward and reverse translate along a horizontal plane indicated by a direction arrow 202. In this manner, all chambers of the basin 101 may be exposed and sealed simultaneously. In some embodiments, a lid 105 includes a top surface 201 that is configured to permit observation of the underlying chamber of the basin 101. For example, the top surface 201 may comprise a translucent or transparent material such that a delivery person may observe food products through the lid. As another example, the top surface 201 may comprise a display having rendered thereon images, video, and/or the like of an underlying chamber. In some embodiments, as shown in FIGS. 24 and 25, the top surface 201 comprises a continuous solid surface, which may be opaque, transparent, or translucent.

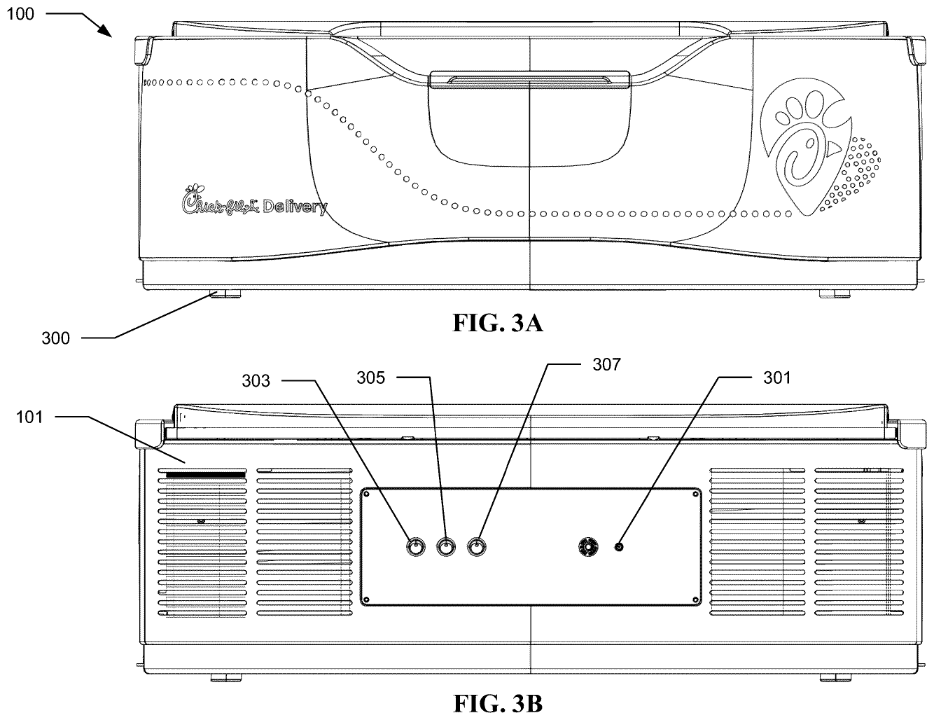

FIG. 3A shows a front view of the holding system 100. In some embodiments, the holding system 100 includes a plurality of legs 300. In some embodiments, the legs 300 provide clearance beneath the holding system 100 to enable air circulation along the bottom surface. In doing so, the legs 300 may improve the efficiency of environment regulation systems, such as heating systems, cooling systems, humidity control systems, and/or the like. In some embodiments, respective heights of the legs 300 are adjustable such that the holding system 100 may be leveled following placement into a vehicle. In some embodiments, the legs 300 are configured to be received into a bracket or other mounting structure within the vehicle.

FIG. 3B shows a rear view of the holding system 100. In some embodiments, the holding system 100 includes one or more inputs 301 configured to receive connectors, plugs, and/or the like for providing power to the holding system 100. For example, the holding system 100 may receive power from the vehicle, such as via a direct current (DC) coupling, alternating current (AC) converter, and/or the like. In some embodiments, the holding system 100 is powered via a connection between a power control input plug and a cigarette lighter outlet in the vehicle. Additionally, or alternatively, in some embodiments, the holding system 100 is powered by one or more internal batteries. In some embodiments, the battery of the holding system 100 is charged by the vehicle. In some embodiments, the holding system 100 is powered by the vehicle while the vehicle engine is engaged. In some embodiments, while the vehicle engine is disengaged, the holding system 100 is powered by one or more internal batteries. In some embodiments, the holding system 100 includes a plurality of power inputs such that environment regulation systems may be independently powered relative to one another. In some embodiments, the holding system 100 includes one or more data ports that enable programming and maintenance monitoring of the holding system 100. For example, the holding system 100 may include one or more universal serial bus type-C (USB-C) ports, and/or the like.

In some embodiments, the holding system 100 includes one or more input interfaces configured for controlling one or more elements of the holding system 100. For example, the holding system may include input interfaces 303, 305, 307 that are configured to control activation and deactivation of environment regulation systems, such as heating systems, cooling systems, humidity control systems, and/or the like. In some embodiments, the input interfaces 303, 305, 307 comprise switches, buttons, touch panels, and/or the like. For example, an input interface 303 may embody a two-stage switch configured to activate and deactivate a cooling system. In some embodiments, the holding system 100 includes a master input interface configured to transition the holding system 100 between powered and depowered states.

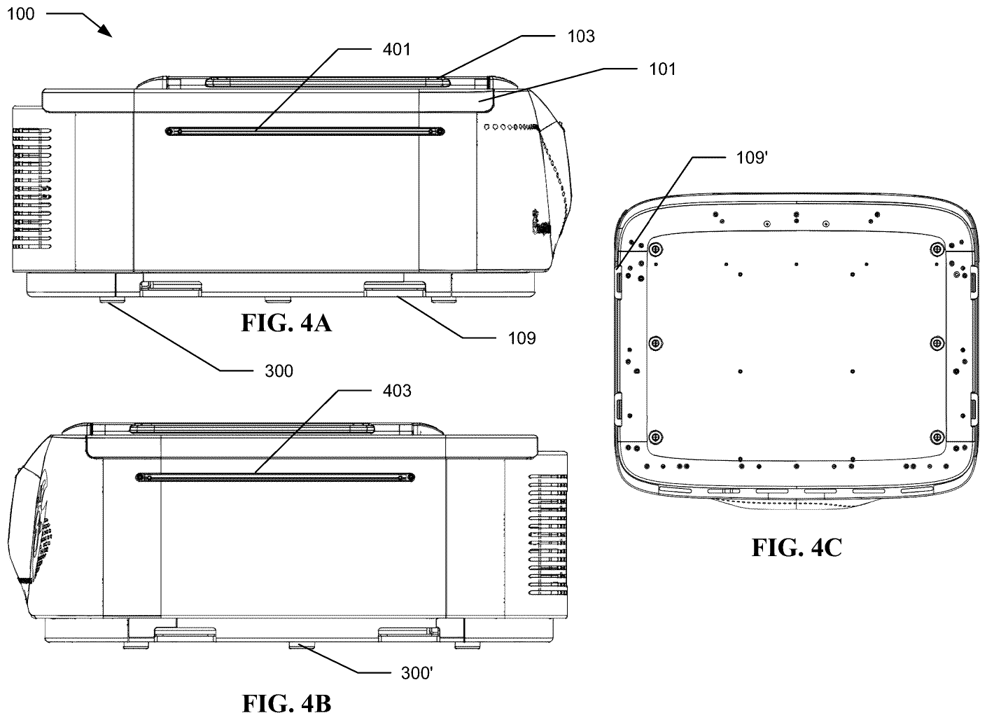

FIGS. 4A and 4B show, respectively, a left-side view, right-side view, and bottom view of the holding system 100. In some embodiments, the holding system 100 includes rails 401, 403 configured to receive modular accessories. For example, as shown in FIGS. 10A-B, the rails 401, 403 may accommodate accessory modules 1001A, 1001B. The accessory modules 1001A, 1001B may comprise one or more chambers 1003 configured to hold utensils, napkins, sauces, straws, drink holders, and/or the like.

FIG. 4C shows a bottom view of the holding system 100.

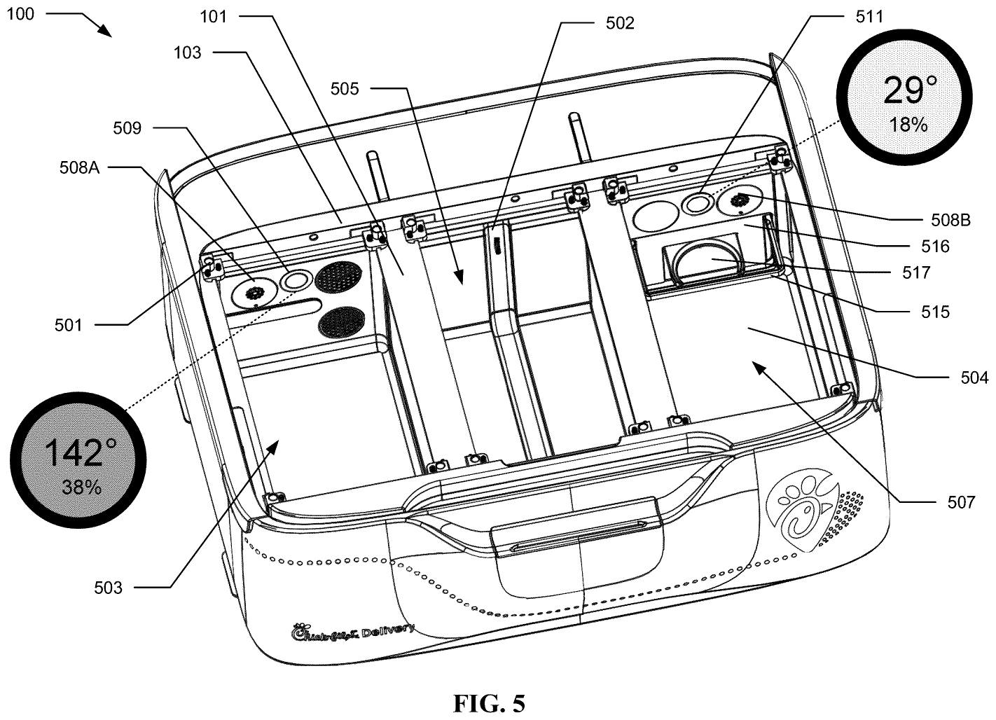

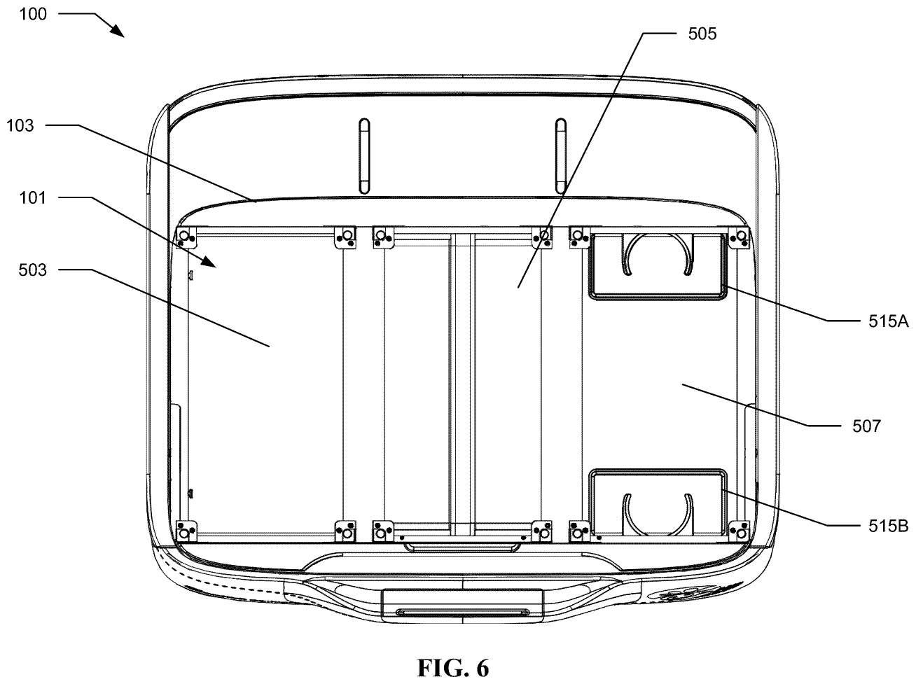

FIG. 5 shows a perspective view of a portion of the holding system 100. To illustrate and describe various aspects of the basin 101 and other interior elements of the holding system 100, FIGS. 5 and 6 omit portions of the door 103 shown in FIGS. 1-3 and 4A-C. For example, FIGS. 5 and 6 illustrate embodiments of the holding system 100 in which the lids 105A, 105B, 105C have been removed. In some embodiments, the door 103 includes a plurality of magnetic elements 501 configured to couple lids to the door 103. For example, the door 103 may include one or more sets of four magnetic elements 501 in a rectangular arrangement, where a respective magnetic element is configured to couple to a corner of a lid 105A, 105B, or 105C (e.g., the lid comprising one or more magnetic or ferromagnetic elements).

In some embodiments, the basin 101 includes a plurality of chambers 503, 505, 507. In some embodiments, the compartmentalization of the basin 101 is configurable such that a delivery person may adjust the dimension of a chamber and create or remove chambers. For example, the basin 101 may be compartmentalized via insertion of one or more articles that partition the volume of the basin 101. In some embodiments, the basin 101 is compartmentalized via insertion of one or more dividers into the basin 101. For example, a divider may be inserted into the basin 101 to partition the basin 101 into two chambers of equal or different volumes depending on the location of the divider within the basin 101. As another example, two dividers may be inserted into the basin 101 to partition the basin 101 into three chambers.

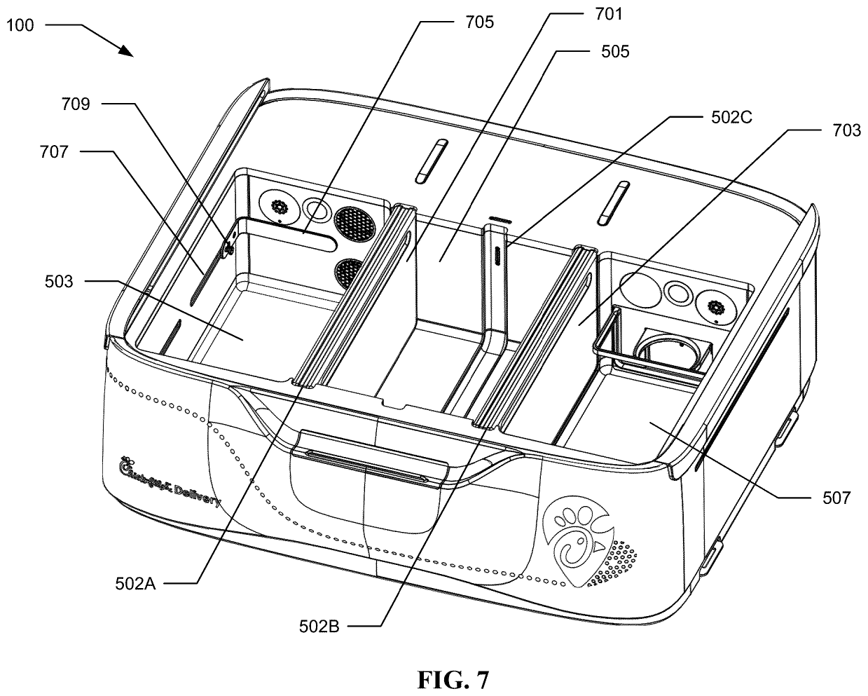

In various embodiments, the basin 101 includes one or more mating surfaces configured to interface with respective engagement surfaces of a divider. The interface of the mating surface and with a corresponding engagement surface may secure and/or stabilize an inserted position of the divider. In some embodiments, the basin 101 includes slots 502 (also referred to as “channels”) into which dividers may be inserted to define a chamber. Alternatively, or additionally, in some embodiments, the divider includes one or more channels configured to receive one or more projections extending from interior walls of the basin 101. Further example aspects of chamber configuration are shown in and described herein with reference to FIGS. 7-9. In various embodiments, the holding system 100 is configured to maintain different environment conditions within chambers 503, 505, 507. For example, the holding system 100 may maintain a hot climate within the chamber 503, an ambient environment within the chamber 505, and a cold climate within the chamber 507. In some embodiments, the arrangement of an ambient temperature chamber between a hot-serve chamber and a cold-serve chamber improves environment regulation processes by providing a buffer region that reduces thermal exchange between the respective hot and cold environments. In some embodiments, the holding system 100 regulates humidity in one or more chambers. For example, the holding system 100 may maintain a target humidity within chamber 503, chamber 505, chamber 507, and/or the like.

In some embodiments, the holding system 100 includes one or more heating systems configured to generate and apply a positive temperature gradient to one or more chambers of the basin 101. For example, the heating system may raise the temperature of and circulate air through the chamber 503 to generate and preserve a hot climate. In doing so, the chamber 503 may be configured to receive and maintain hot-serve food products within a target temperature range. For example, the heating system may maintain a temperature of 142 degrees Fahrenheit (or another suitable temperature) within the chamber 503. The heating system may oppose cooling of the inserted food products and actively heat the food products during delivery. In some embodiments, the heating system is configured to apply sufficient heat to a chamber such that a cooking process for one or more food products is completed over the course of delivery. In doing so, the heating system may improve the efficiency and throughput of both food delivery and food preparation processes. In some embodiments, the heating system includes one or more positive temperature coefficient (PTC) air heaters configured to heat and circulate air through the chamber 503. In some embodiments, the heating system includes one or more fans, air pumps, and/or the like that are configured to circulate air through the chamber 503 and heating system. In some embodiments, the chamber 503 and heating system are sealed against an external environment such that heated air is maintained within and recirculated through the chamber. In this manner, the holding system 100 may increase the thermal efficiency and power efficiency of maintaining a hot climate within the chamber 503.

In some embodiments, the holding system includes one or more cooling systems configured to generate and apply a negative temperature gradient to one or more chambers of the basin 101. For example, the cooling temperature may lower the temperature of and circulate air through the chamber 507 to generate and preserve a cold climate. In doing so, the chamber 507 may be configured to receive and maintain cold-serve food products within a target temperature range. For example, the cooling system may maintain a temperature of 29 degrees Fahrenheit (or another suitable temperature) within the chamber 507. The cold climate may maintain iced beverages, smoothies, desserts, and/or the like at desired temperatures, textures, and/or the like. The cooling system may oppose warming of the inserted food products and actively cool the food products during delivery. In some embodiments, the cooling system may reverse warming effects of food product packaging and staging operations. For example, a frozen dessert may immediately begin to cool following removal from a freezer at the QSR. The frozen dessert may rise above a target temperature range for serving during packaging and staging operations. The placement of the frozen dessert into the chamber 507 during its delivery journey may lower the temperature of the frozen dessert into the target temperature range, thereby maintaining food quality and texture.

In some embodiments, the cooling system includes one or more compressor-based refrigeration modules configured to cool and circulate air through the chamber 507. In some embodiments, the cooling system includes one or more fans, air pumps, and/or the like that are configured to circulate air through the chamber 507 and cooling system. In some embodiments, the chamber 507 and heating system are sealed against an external environment such that cooled air is maintained within and recirculated through the chamber. In this manner, the holding system 100 may increase the thermal efficiency and power efficiency of maintaining a cold climate within the chamber 507. In some embodiments, one or more surfaces of the basin 101 include an evaporator plate configured to exchange heat between the basin 101 and a refrigerant or the external environment. For example, a portion of a bottom surface 504 associated with the chamber 507 may include an evaporator plate configured to transfer heat from the chamber 507 to a refrigerant that is external to the chamber 507. In some embodiments, the evaporator plate opposes changes in the temperature gradient within the chamber 507 upon its exposure to the external environment via opening of the door 103 or lid 105C.

In some embodiments, the humidity control system is configured to control levels of water vapor in one or more chambers of the basin 101. For example, the humidity control system may maintain a target humidities of 38% and 18% in the chamber 503 and the chamber 507, respectively. In some embodiments, the humidity control system includes one or more mechanisms configured to condense and remove liquid water from the circulating within one or more chambers. For example, the humidity control system may include evaporator coils, fans, blowers, and/or the like that remove water from the air and circulate the dehumidified air into the chamber 505. In some embodiments, the hot climate of the chamber 503 and the cold climate of the chamber 507 enable the central chamber 505 to be configured with a humidity-controlled climate. For example, the humidity control system may regulate respective airflows between the chambers 503, 505, 507 to control humidity levels within one or more of the chambers. The humidity control system may receive hot, humid air from the chamber 503 and cold, dry air from the chamber 507. The humidity control system may combine the airflows in a predetermined ratio to generate an air supply having a target temperature and humidity. The humidity control system may release the air supply into the central chamber 505 to regulate the humidity and/or temperature therein. As another example, the humidity control system may output air from the chamber 505 or chamber 507 into the chamber 503 to reduce humidity levels within the chamber 503 (e.g., which may be elevated due to greater moisture retention of the hot climate).

Additionally, or alternatively, in some embodiments, the humidity control system includes a permeable membrane configured within one or more surfaces of the basin 101. For example, a rear surface of the basin 101 may comprise a permeable membrane. In some embodiments, the permeable membrane comprises pores onto which water vapor may condense into liquid droplets. In various embodiments, the holding system 100 comprises one or more air circulation elements (e.g., fans, blowers, pumps, and/or the like) external to the basin 101. The air circulation elements may be configured to direct airflow over the permeable membrane to evaporate the droplets and expel the water from the basin 101, thereby reducing the humidity level within one or more chambers.

In some embodiments, one or more of the heating system, cooling system, and humidity control system are repositionable within the holding system 100. For example, the heating system, cooling system, humidity control system, and/or the like may embody modular units configured to be temporarily installed and connected to a chamber. In this manner, a delivery person may reposition the layout of hot-serve, cold-serve, ambient, and humidity-controlled chambers within the basin 101. Further, a delivery person may add or remove environment control systems. For example, a delivery person may replace a cooling system with an additional heating system, or vice versa. As another example, a delivery person may install an additional cooling system such that a previous ambient-serve chamber is converted into a cold-serve chamber (e.g., independent from or in combination with an existing cold-serve chamber).

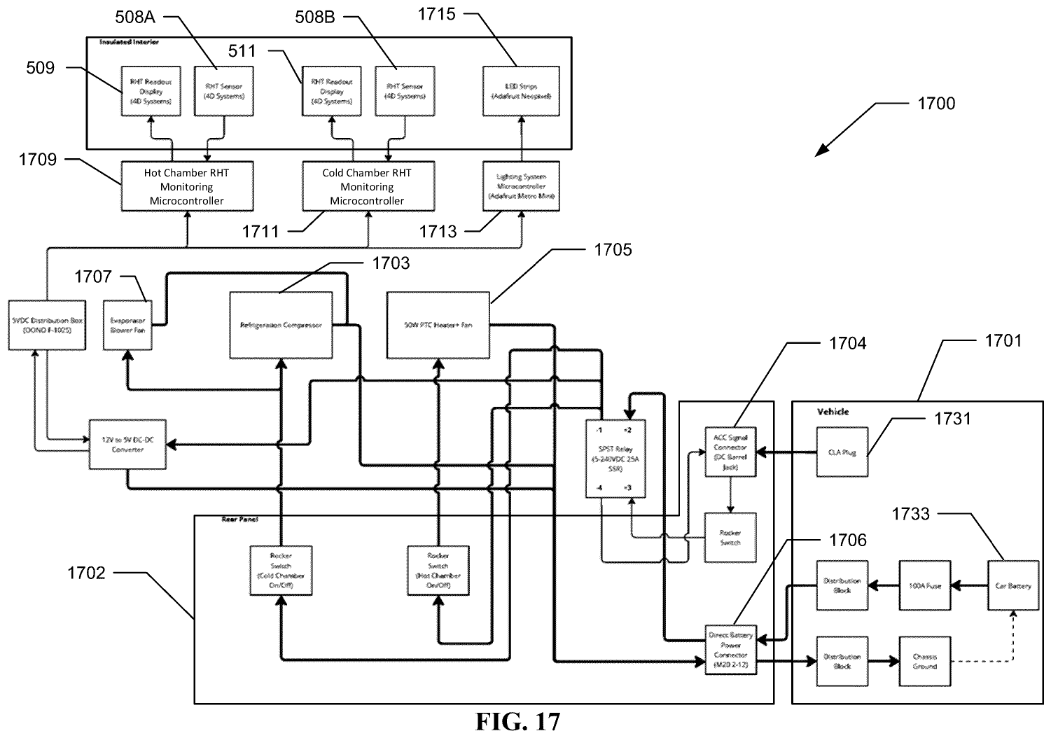

In some embodiments, as further shown in FIG. 17, the holding system 100 includes one or more relative humidity and temperature (RHT) sensors 508A, 508B configured to measure temperature and humidity levels within portions of the basin 101. For example, the holding system 100 may include a first RHT 508A configured to measure temperature and humidity levels in a portion of the basin 101 that embodies the chamber 503. The holding system 100 may include a second RHT 508B configured to measure temperature and humidity levels in a portion of the basin that embodies the chamber 507. In various embodiments, the basin 101 includes one or more interfaces configured to indicate temperature, humidity level, and/or the like within a chamber of the basin. In some embodiments, an interface comprises displays, lighting elements, auditory elements, and/or the like. For example, the basin 101 may include a first display 509 configured to render a current temperature and humidity level of the chamber 503. The rendered contents of the first display 509 may include red colorations that indicate hot climate conditions within the chamber 503. The basin 101 may further include a second display 511 configured to render a current temperature and humidity level of the chamber 507. The rendered contents of the second display 511 may include blue colorations indicative of cold climate conditions within the chamber 507. As another example, while not shown in FIG. 5, the door 103, lids 105A, 105C, and/or the like may include displays configured to render temperature and humidity measurements of one or more chambers. In some embodiments, the interfaces for indicating temperature and humidity levels are further configured to indicate whether the current temperature, humidity level, and/or the like meet target thresholds or ranges.

In some embodiments, the basin 101 includes one or more lighting elements configured to indicate whether a current temperature of a chamber is within a target range. For example, a lighting element may be configured to output light of a first color, first frequency, and/or the like when a current temperature of the chamber 503 is within a target range. The lighting element may be configured to output light of a different color and/or frequency in response to the current temperature of the chamber 503 falling outside of the target range. In some embodiments, the basin 101, door 103, lids, and/or the like includes lighting elements configured to indicate a climate configuration of a chamber. For example, a lid associated with the chamber 503 may include a lighting element configured to emit a red light (e.g., indicating hot climate conditions). As another example, a lid associated with the chamber 507 may include a lighting element configured to emit blue light (e.g., indicating cold climate conditions).

Additionally, in some embodiments, the holding system 100 is configured to provision temperature measurements, humidity measurements, and/or the like to a computing device of a delivery person, QSR operator, and/or the like (e.g., for storage and/or rendering thereon). In some embodiments, the holding system 100 is configured to provision an alert to the computing device in response to determining that the current temperature, humidity level, and/or the like of one or more chambers fail to satisfy target thresholds or ranges. For example, the holding system 100 may provision an alert to a computing device in response to determining that temperature within a cold-serve chamber has risen above a target range during the delivery journey. As another example, the holding system 100 may provision an alert to a computing device in response to determining that a current temperature within a hot-serve chamber is below a target range.

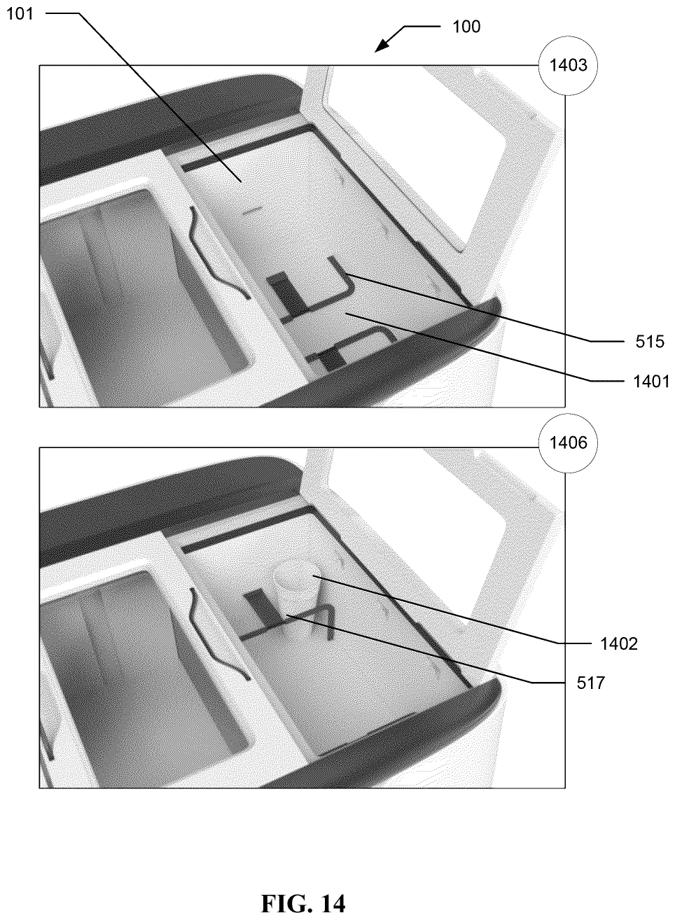

In some embodiments, the basin 101 includes one or more cupholders 515 configured to accommodate and stably support a beverage. In some embodiments, as further shown in FIG. 14, a cupholder 515 is configured to transition between a stowed configuration and a deployed configuration. For example, in a stowed configuration, the cupholder 515 may be rotated and collapsed downward such that the cupholder 515 lies flat against a side surface of the basin 101 (or a bottom surface of the basin 101, as shown FIG. 14, indicium 1403). In the deployed configuration, the cupholder 515 may be rotated and expanded upward such that the cupholder 515 defines one or more receptacles 517 into which a beverage 1402 may be inserted (see indicium 1406 in FIG. 14). As another example, as shown in FIG. 12, the cupholder 515 may define a receptacle 1202 configured to receive a beverage carrier 1204 (see indicium 1212).

In some embodiments, the basin 101 includes one or more grated panels configured to provide a vertical offset between the bottom surface of the basin 101 and food products placed into the holding system 100. The grated panels may be positioned within one or more chambers to elevate food products, bags, and containers above the bottom surface. In this manner, the grated panels may prevent food products from coming into direct contact with accumulated moisture on the bottom surface of the basin 101. The grated panels may include perforations or openings that allow air circulation while providing structural support for the food products positioned thereon.

FIG. 6 shows a top view of a portion of the holding system 100. In some embodiments, the basin 101 includes multiple cupholders 515A, 515B. In some embodiments, the cupholders 515A, 515B are positioned within a cold-serve chamber, such as the chamber 507. Additionally, or alternatively, in some embodiments, the basin 101 comprises cupholders positioned within hot-serve chambers (e.g., chamber 503) or ambient and/or humidity-controlled chambers (e.g., chamber 505).

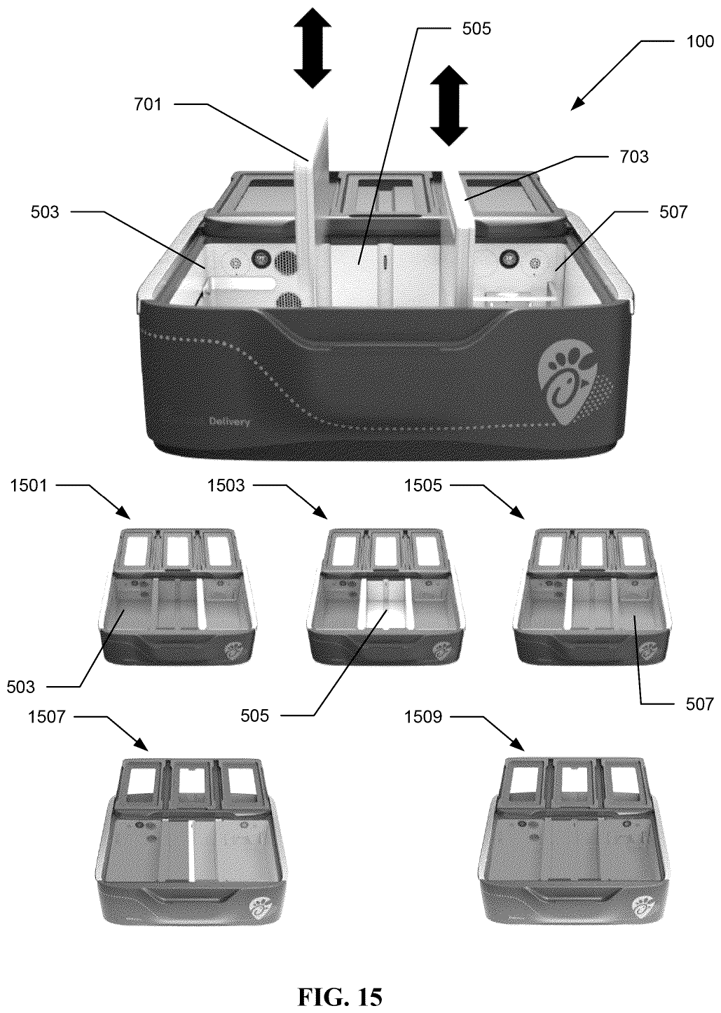

FIG. 7 shows a perspective view of a portion of the holding system 100. To illustrate and describe various aspects of the basin 101 and other interior elements of the holding system 100, FIGS. 7-9 omit the door 103 shown in FIGS. 1-6. In various embodiments, the basin 101 includes a plurality of channels configured for compartmentalization of the basin 101. In some embodiments, a channel is configured to receive a divider. For example, as shown in FIG. 15, dividers 701 and 703 may be inserted into respective channels to compartmentalize the basin 101 into three chambers. In various embodiments, a divider spans a length of the basin 101. In doing so, the respective climates of chambers may be isolated from one another via the divider. In various embodiments, the basin 101 includes 2, 3, 5, or any suitable number of channels. For example, the basin 101 may include includes a first channel 502A, a second channel 502B, and a third channel 502C. A first divider 701 may be inserted into the first channel 502A such that the basin 101 is divided into a first chamber and a second chamber. As further shown in FIG. 7, a second divider 703 may be inserted into the second channel 502B such that the basin 101 is further divided into three chambers (e.g., chambers 503, 505, and 507, respectively). In some embodiments, a divider includes one or more insulative materials configured to minimize thermal transfer between chambers. For example, a divider may include expanded polystyrene (EPS) foam that reduces thermal transfer through the divider.

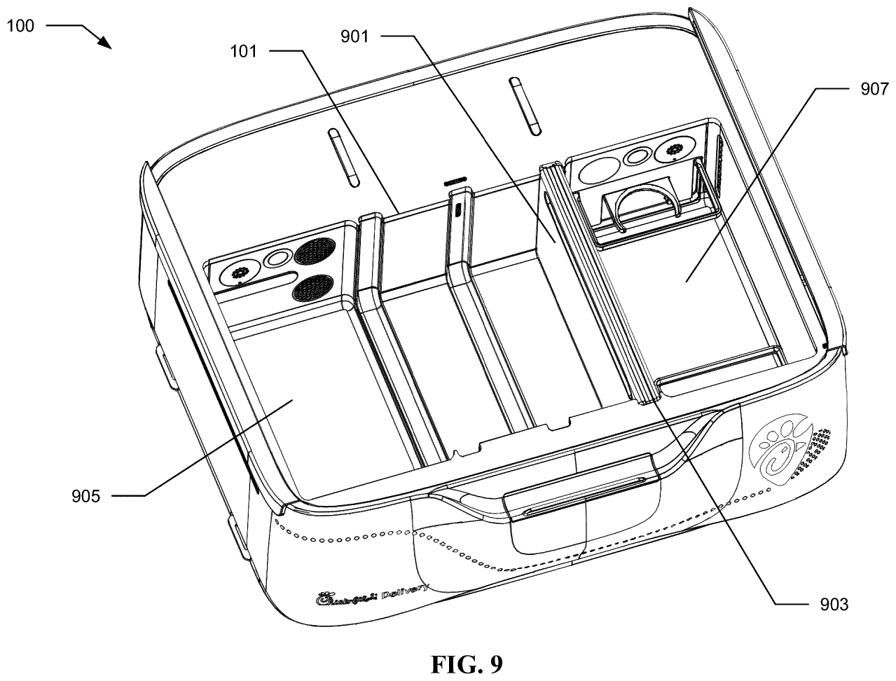

As shown in FIG. 15, the compartmentalization of the basin 101 may be configured in a plurality of combinations based on the objective of the delivery person and food products to be placed within the holding system. In some embodiments, using a single channel and divider, the basin 101 is compartmentalized into a cold-serve chamber and a hot-serve chamber of equal dimension (see indicium 1501) or varying dimension (see indicia 1501, 1507). In some embodiments, a larger hot-serve chamber or cold-serve chamber is configured to accommodate catering trays, beverage containers, and/or the like. For example, as shown in FIG. 9, a single divider 901 may be inserted into a channel 903 such that the basin 101 is compartmentalized into a large hot-serve chamber 905 and a small cold-serve chamber 907. In some embodiments, using two dividers and two channels, the basin 101 is compartmentalized into three chambers including a hot-serve chamber, an ambient and/or humidity-controlled chamber, and a cold-serve chamber (see indicium 1503). In some embodiments, the basin 101 is not compartmentalized such that the basin comprises a single climate-controlled environment. For example, by removing all dividers the basin 101 may be configured to a single hot-serve, cold-serve, or ambient and/or humidity-controlled chamber (see indicium 1509).

In some embodiments, the channels, dividers, and/or the like include one or more means for securing the inserted position of the divider. For example, the channels, dividers, and/or the like may include magnetic elements, ferromagnetic elements, and/or the like that engage with one another to secure the divider within the channel. Indeed, in some embodiments, the use of channels may not be necessary if the divider is otherwise so engaged within the basin 101 as to secure the divider in a desired position. In some embodiments, the dividers, channels, and/or the like include rubberized seals to prevent movement of air, fluids, and/or the like between chambers. In some embodiments, the holding system 100 includes internal ducts that are controlled to permit or prevent airflow between chambers. For example, the holding system 100 may include a first duct between chambers 503, 505 and a second duct between chambers 505, 507. The holding system 100 may include means for blocking or opening the first and second ducts to control the circulation of hot and cold airflows into the chamber 505.

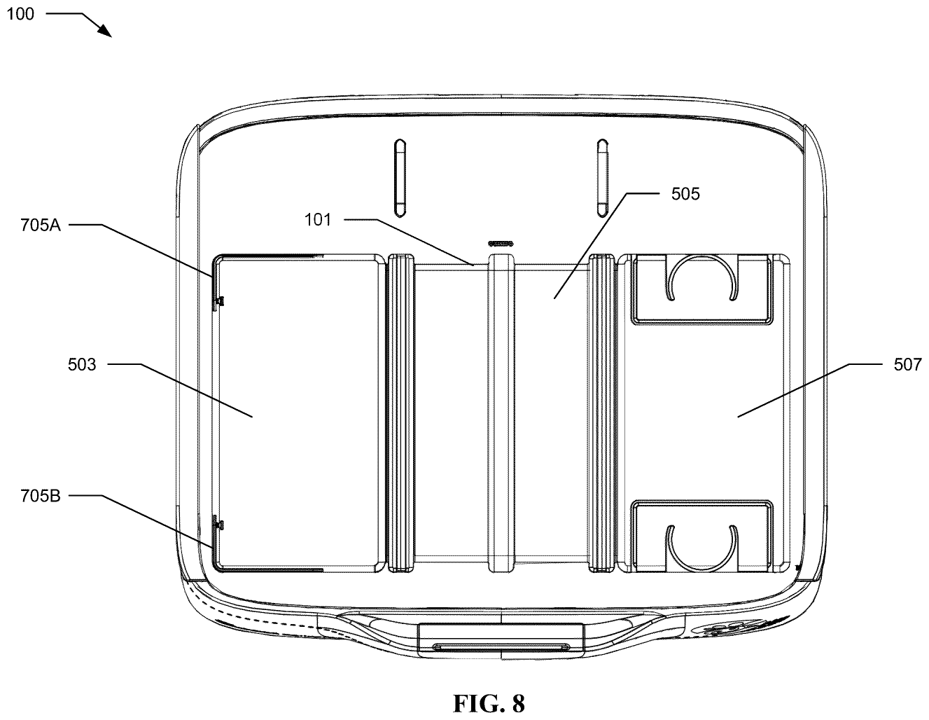

In some embodiments, the basin 101 includes one or more adjustable subdividers 705 configured to segment a chamber into one or more zones. In some embodiments, a subdivider 705 is configured to translate along a channel 707. For example, a delivery person may slide the subdivider 705 along the channel 707 to partition the chamber 503 into two zones. A first order may be placed into a first zone and a second order may be placed into a second zone. In this manner, the subdividers 705 may enable a delivery person to organize orders within the basin 101 for more efficient differentiation and retrieval. In contrast, other approaches may require a delivery person to sort through bags and inspect packaging labels to identify and retrieve a desired order, thereby reducing delivery efficiency. In some embodiments, a locking mechanism 709 secures a position of the subdivider along the channel 707. The locking mechanism 709 may be biased toward an engaged state and may be temporarily transitioned to a disengaged state by a delivery person to enable repositioning of the subdivider 705. As shown in FIG. 8, the basin 101 may include multiple subdividers 705A, 705B. While depicted in association with the chamber 503, the basin 101 may include any suitable number of subdividers in various locations such that additional chambers may be segmented into two or more zones.

FIGS. 11 and 12 show example loading sequences of a holding system 100. In some embodiments, the holding system 100 is installed within a trunk portion of a vehicle 1100 (see indicia 1103, 1203). In some embodiments, a carrying system 1000 is nested atop a staging table 1201 to facilitate loading or unloading of food products into or from the holding system 100 (see indicium 1203). In various embodiments, when the door 103 and lids 105A, 105B, 105C are configured to a closed state, the holding system 100 is sealed against the external environment (see indicium 1206). The door 103 may be slid to an open state to fully expose the interior volume of the basin 101 (see indicium 1109, 1212). For example, the door 103 may be slid open to simultaneously expose chambers 503, 505, 507. A delivery person may open the door 103 to adjust the compartmentalization of the basin 101 (e.g., adding or removing dividers), organize food products into one or more chambers, or retrieve food products.

In some embodiments, a delivery person may place a computing device 1101 onto a device platform during loading or unloading of the holding system 100 (see indicium 1112). In various embodiments, a graphical user interface (GUI) 1102 is rendered on a display of the computing device 1101. In some embodiments, the GUI 1102 comprises information associated with order composition and fulfillment. For example, the GUI 1102 may comprise order recipient information (e.g., name, address, and/or the like), promised order times, order composition, and/or the like. In some embodiments, the GUI 1102 indicates a climate-based organizational schema for the contents of the order. For example, the GUI 1102 may comprise a hot-serve listing 1104 and a cold-serve listing 1104. The hot-serve listing 1104 may indicate one or more food products for placement within a hot-serve chamber of the holding system 100 (e.g., chamber 503). The cold-serve listing 1105 may indicate one or more food products for placement within a cold-serve chamber of the holding system 100 (e.g., chamber 507). The contents of the GUI 1102 may assist a delivery person with efficiently loading food products into and removing orders from the holding system 100. In some embodiments, the GUI 1102 further comprises one or more interfaces for controlling the holding system 100. For example, the GUI 1102 may include interfaces for controlling the temperature, humidity, and/or the like of one or more chambers.

In some embodiments, the lids 105A, 105B, 105C are independently openable such that the various chambers of the basin 101 may be independently accessed without exposing other chambers to the external environment (see indicia 1106, 1209). In this manner, the internal climates of the chambers may be undisturbed by the opening of another chamber. As a result, the temperature and moisture of food products in the unopened chambers may be better maintained within their target ranges. For example, a first order may include an ambient-serve food product and a plurality of cold-serve products, and a second order may include hot-serve food products. A delivery person may deposit the food products of the first and second orders into corresponding chambers of the holding system 100. The compartmentalization and independent lids of the holding system 100 may enable the delivery person to retrieve the food products of the first order without exposing any of the food products of the second order to external environment conditions. In this manner, the second order may be preserved and provided to a customer in accordance with target temperatures and textures despite being delivered later in the delivery order. In other scenarios where food products of multiple orders share one or more chambers, the environment regulation systems of the holding system 100 may oppose deviations in temperature and humidity introduced by opening of the lid or door.

FIG. 13 shows example bi-directional lids 105, 105′ of a holding system 100. As shown a lid 105, 105′ may include multiple hinges that enable bidirectional opening. For example, the lid 105, 105′ may be rotated open in a first direction 1301 or a second direction 1303, the first and second directions being opposite one another. In some embodiments, the bidirectionally of the lids enable a chamber to be more fully exposed. For example, as shown in FIG. 9, a chamber 905 may extend across a footprint of multiple lids. To expose the chamber 905, a first lid may be rotated in the first direction 1301 and a second lid (adjacent to the first lid) may be rotated in the second direction 1303. In this manner, the chamber 905 may be exposed without occluding the viewing angle of a delivery person.

FIG. 16 shows a perspective view of a holding system 1600. In some embodiments, the holding system 1600 comprises an equal or lesser footprint as compared to the holding system 100 shown in FIGS. 1-15. For example, the holding system 1600 may demonstrate a lesser footprint as compared to the holding system 100 such that a single passenger seat may accommodate the holding system 1600. In some embodiments, the holding system 1600 includes a door 103 comprising a pair of lids 1601A, 1601B configured to open bidirectionally to expose a basin 101. In some embodiments, similar to the holding system 100, the basin 101 of the holding system 1600 is compartmentalizable into two or more chambers via insertion of one or more dividers into respective channels within the basin 101. For example, the holding system 1600 may be configured to comprise a single chamber or a pair of chambers comprising a cold-serve chamber and hot-serve chamber, amongst other possible climate combinations.

FIG. 17 shows a system architecture 1700 of a holding system 100 and vehicle 1701. In various embodiments, the elements of the holding system 100 depicted in FIG. 17 and described herein are present in other embodiments of holding systems presented in the disclosure. For example, the holding system 1600 may comprise similar elements to those shown in FIG. 17 and described herein.

In various embodiments, the vehicle 1701 is configured to provide power to the holding system 100. For example, the holding system 100 may include a power input 1704 configured to connect to a cigarette lighter adapter (CLA) plug 1731 of the vehicle 1701. As another example, the holding system 100 may include a direct battery power connector 1706 configured to draw power directly from the battery 1733 of the vehicle 1701. In some embodiments, as shown in FIG. 3B, the holding system 100 includes a control panel 1702 comprising interfaces for controlling one or more elements of the holding system 100. In some embodiments, the control panel 1702 comprises interfaces for controlling one or more cooling systems 1703, heating systems 1705, one or more humidity control systems 1707, an overall power state of the holding system 100, and/or the like.

The operations of the holding system 100 may be controlled by any suitable number of computing elements embodied in hardware, software, firmware, and/or the like. The computing elements may be internal to or remote from the holding system 100. Alternatively, a first set of computing elements may be internal to the holding system 100 and a second set of computing elements may be external to the holding system 100. For example, one or more operations of holding system 100 may be remotely controlled by a delivery person's computing device configured to communicate with one or more computing elements internal to the holding system 100. In some embodiments, operations of the holding system 100 include heating, cooling, humidifying, dehumidifying, monitoring chamber environment, provisioning data (e.g., environment conditions, food product hold times, power states, and/or the like), configuring lighting elements, and/or the like.

In some embodiments, the holding system 100 includes one or more microcontrollers configured to independently control the respective means for generating hot, cold, and humidity climates within the one or more chambers. For example, the holding system 100 may include a first microcontroller 1709 configured to receive measurements from RHT sensors 508A, render environment conditions on a display 509, and control one or more heating systems 1705 for maintaining a hot climate within a hot-serve chamber. As another example, the holding system 100 may include a second microcontroller 1711 configured to receive measurements from RHT sensors 508B, render environment conditions on a display 511, and control one or more cooling systems 1703 for maintaining a cold climate within the cold-serve chamber. In some embodiments, the holding system 100 includes a third microcontroller 1713 configured to control one or more lighting elements 1715. For example, the third microcontroller 1713 may control lighting elements configured to indicate a climate-type of a chamber, environment conditions in the chamber, and/or the like.

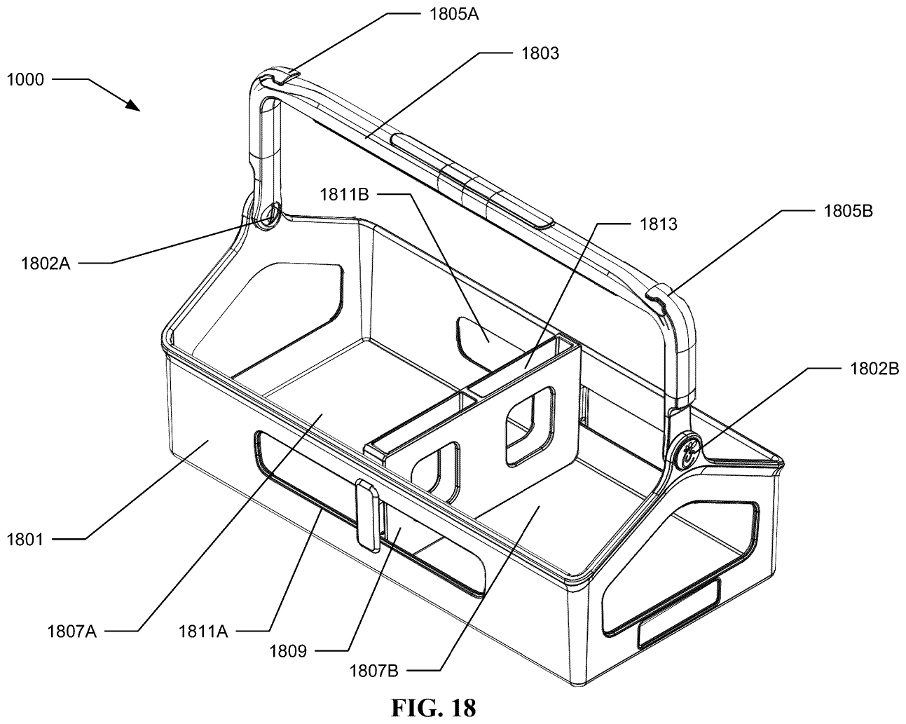

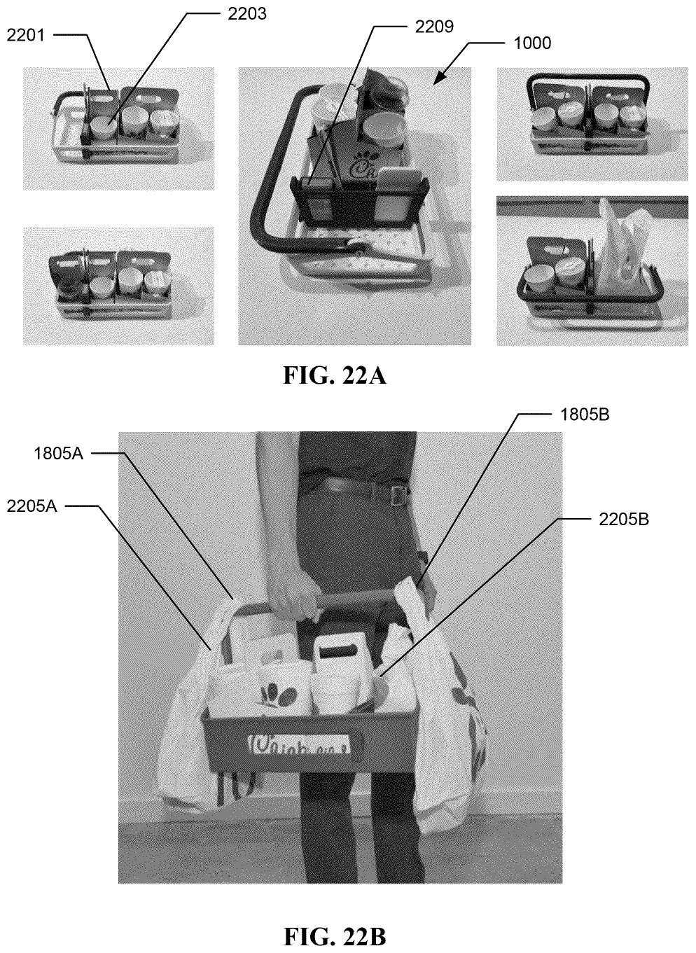

FIG. 18 shows a perspective view of an example carrying system 1000. In various embodiments, the carrying system 1000 is configured to receive and stably support a plurality of food products and other products associated with food delivery (e.g., beverage holders, bags, straws, utensils, and/or the like). For example, as shown in FIGS. 22A, 22B, the carrying system 1000 may accommodate beverage carriers 2201, beverages 2203, bags 2205A, 2205B, condiments 2207, and/or the like. A respective bag 2205A, 2205B may comprise food products associated with a particular order. Thus, as depicted in FIG. 22B, the carrying system 1000 may enable a delivery person to carry multiple orders worth of food products with one hand (e.g., leaving a remaining hand free to manipulate doors and vehicle controls, control a computing device, and/or the like). In doing so, the carrying system 1000 may increase the efficiency and safety of delivery operations.

In various embodiments, the carrying system 1000 includes a basket 1801 and a handle 1803 connected to the basket 1801. In some embodiments, a connection 1802A, 1002B between the handle 1803 and basket 1801 is pivotable such that the handle 1803 may rotate relative to the basket 1801. In doing so, the handle 1803 may be rotated toward the basket 1801 to reduce a spatial footprint of the carrying system 1000. For example, as shown in FIG. 10A, the handle 1803 may be rotated downward to improve storage efficiency of the carrying system 1000 within the holding system 100. In some embodiments, the handle 1803 comprises hooks 1805A, 1805B configured to receive bag straps. For example, as shown in FIG. 22B, the hooks 1805A, 1805B may enable one or more bags 2205A to be supported by the carrying system 1000, thereby increasing the carrying capacity of a delivery person.

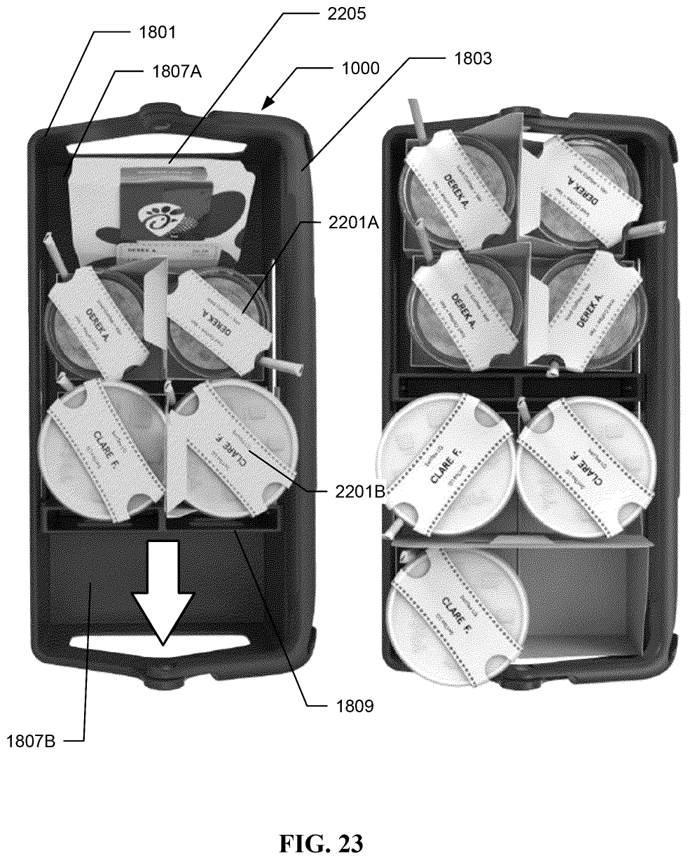

In some embodiments, the basket 1801 is compartmentalizable into two or more chambers via one or more dividers 1809. For example, the basket 1801 may include channels 1811A, 1811B configured to receive one or more dividers 1809. A divider 1809 may span a width of the basket 1801 such that a first chamber 1807A and a second chamber 1807B are formed within the basket 1801 upon insertion of the divider 1809 into the channels 1811A, 1811B. In various embodiments, the divider 1809 is configured to translate along the channels 1811A, 1811B such that respective dimensions of the chambers 1811A, 1811B may be adjusted by repositioning the divider 1809. The compartmentalization of the basket 1801 may enable a delivery person to better organize food products based on order association. For example, as shown in FIG. 23, a delivery person may segregate orders between chambers, thereby increasing efficiency of identifying and retrieving appropriate items for fulfilling an order. As another example, also shown in FIG. 23, a delivery person may dynamically adjust the compartmentalization throughout order fulfillments by sliding the divider 1809. In some embodiments the divider 1809 comprises one or more compartments 1813 configured to receive food products or other items, such as condiments, utensils, straws, and/or the like.

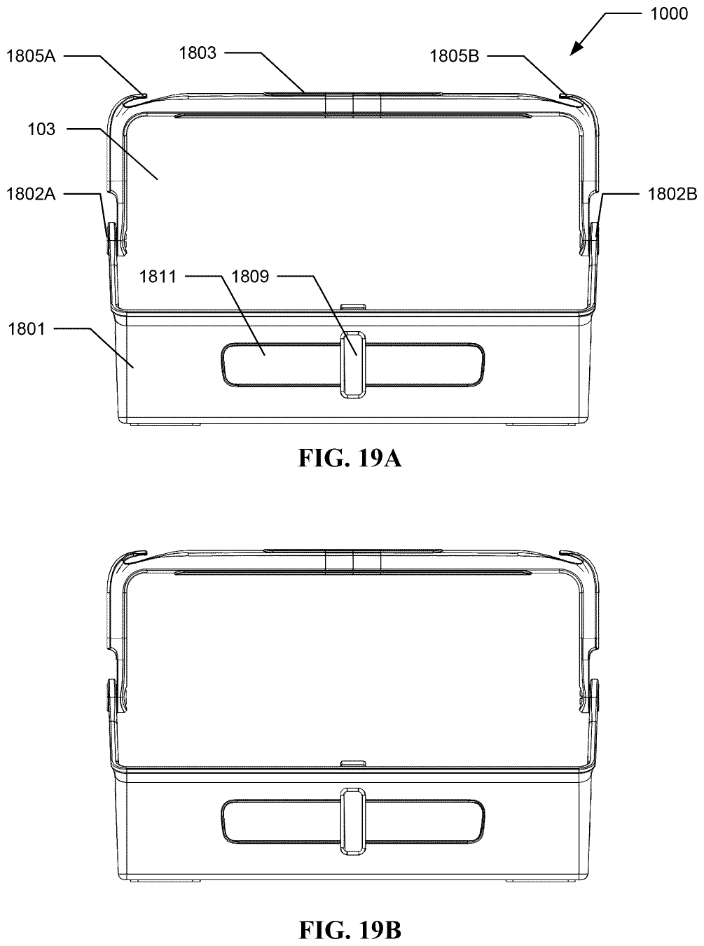

FIG. 19A shows a left-side view of the carrying system 1000.

FIG. 19B shows a right-side view of the carrying system 1000.

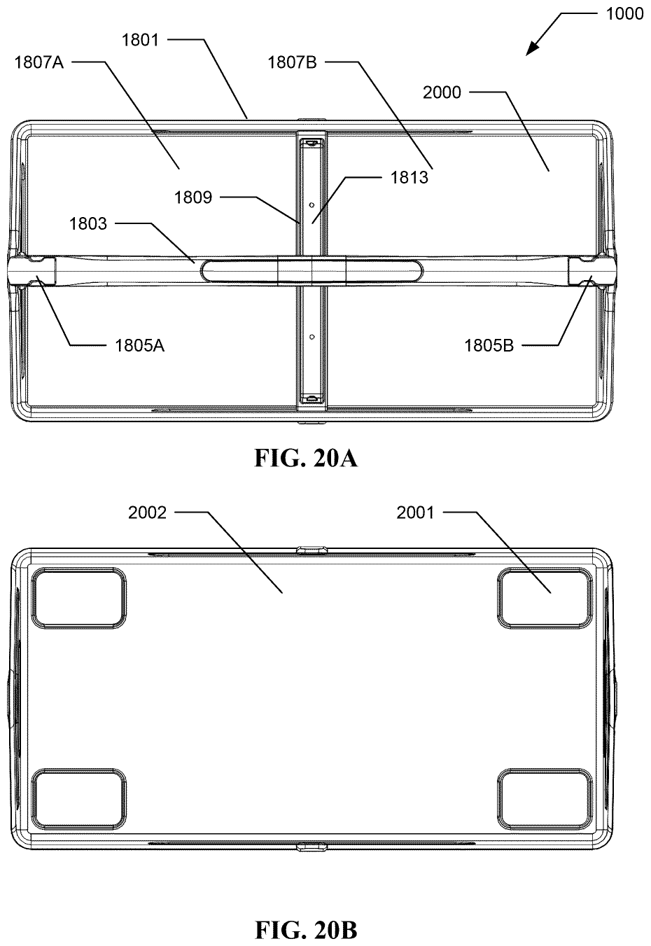

FIG. 20A shows a top view of the carrying system 1000. In some embodiments, a surface 2000 of the basket 1801 is textured to increase friction along the surface. In some embodiments, the texturization of the surface 2000 opposes shifting of beverages, beverage carriers, and/or the like during the delivery journey. In some embodiments, the surface 2000 is perforated to improve airflow circulation through the basket 1801.

FIG. 20B shows a bottom view of the carrying system 1000. In some embodiments, the basket 1801 includes a plurality of legs 2001 configured to provide an offset between a bottom surface 2002 of the basket 1801 and a surface upon which the basket 1801 rests. In some embodiments, the legs 2001 comprise texturized surfaces configured to oppose shifting of the carrying system 1000.

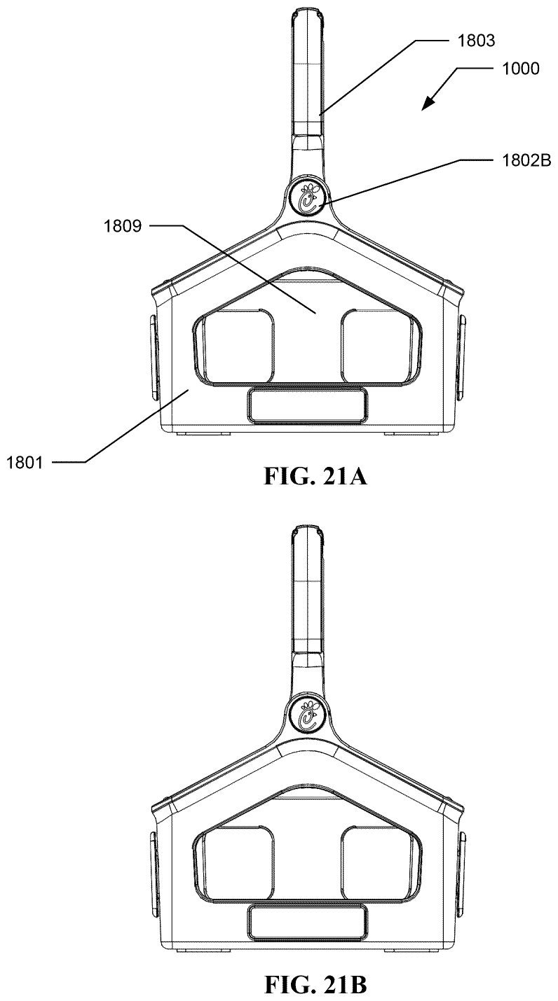

FIG. 21A shows a front view of the carrying system 1000.

FIG. 21B shows a back view of the carrying system 1000.

FIGS. 22A-B show example loading arrangements of the carrying system 1000. The compartmentalization of the carrying system 1000 may be adjusted to accommodate beverage carriers, beverages, bags, and/or the like. Additionally, the compartmentalization of the carrying system 1000 may be configured to segregate food products associated with different orders, thereby improving efficiency of order identification and retrieval. In some embodiments, one or more bagged orders may be attached to the carrying system 1000. For example, bags 2205A, 2205B may be attached to the carrying system 1000 via hooks 1805A, 1805B.

FIG. 23 shows an exemplary chamber reconfiguration of the carrying system 1000. In some embodiments, the position of the divider 1809 is adjusted to increase or decrease the dimensions of the chambers 1807A, 1807B.

FIG. 24 shows a perspective view of a holding system 100 in accordance with some embodiments of the present disclosure. The holding system 100 includes a basin 101 and a door 103 configured to cover the basin 101. In some embodiments, the basin 101 includes a grated panel 2401 positioned within the interior volume to provide a vertical offset between a bottom surface of the basin 101 and food products placed within the holding system 100. For example, the cooling system 2403 may generate moisture during operation, and the grated panel 2401 may provide a beneficial vertical offset that prevents bags, food products, and/or the like from coming into direct contact with any accumulated moisture on the bottom surface of the basin 101. The grated panel 2401 may include perforations or openings that allow air circulation while providing structural support for food products positioned thereon. In some embodiments, the holding system 100 includes a lighting element 2405 configured to illuminate the interior volume of the basin 101 to enhance visibility during loading and unloading operations. The lighting element 2405 may be activated automatically in response to opening of the door 103 or may be controlled manually via the control panel to provide adequate illumination in low-light conditions.

FIG. 25 shows a perspective view of a holding system 100 positioned within a vehicle 2500 in accordance with some embodiments of the present disclosure. In various embodiments, the holding system 100 is installed within a trunk 2501 of the vehicle 2500. In some embodiments, a top surface of the door 103 functions as a staging surface for organizing orders prior to placement within the chambers or for temporarily holding items during loading and unloading operations.

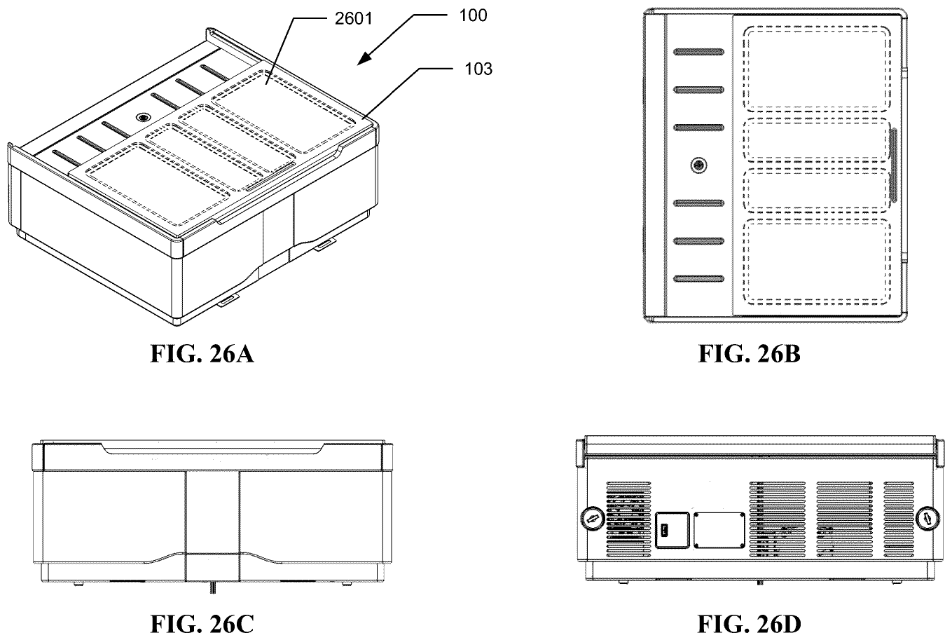

FIG. 26A shows a perspective view of an example holding system 100. In some embodiments, the door 103 comprises one or more indentations 2601, which may receive and stabilize food carrying systems. For example, the indentation may be configured to receive the carrying system 1000.

FIG. 26B shows a top view of an example holding system 100. FIGS. 26A and B demonstrate additional compartmentalization configurations of the holding system 100. In some embodiments, as shown in FIGS. 26A and 26B, the basin 101 is compartmentalized into four chambers. For example, the compartmentalization may be configured such that two chambers at either end each comprise approximately 40% of the basin volume, while two central chambers each comprise approximately 10% of the basin volume. In various embodiments, the asymmetric chamber configuration enables a delivery person to allocate larger volumes for primary food items while providing smaller dedicated spaces for accessories, condiments, or specialized items that require separate environmental conditions.

FIG. 26C shows a front view of an example holding system 100.

FIG. 26D shows a back view of an example holding system 100.

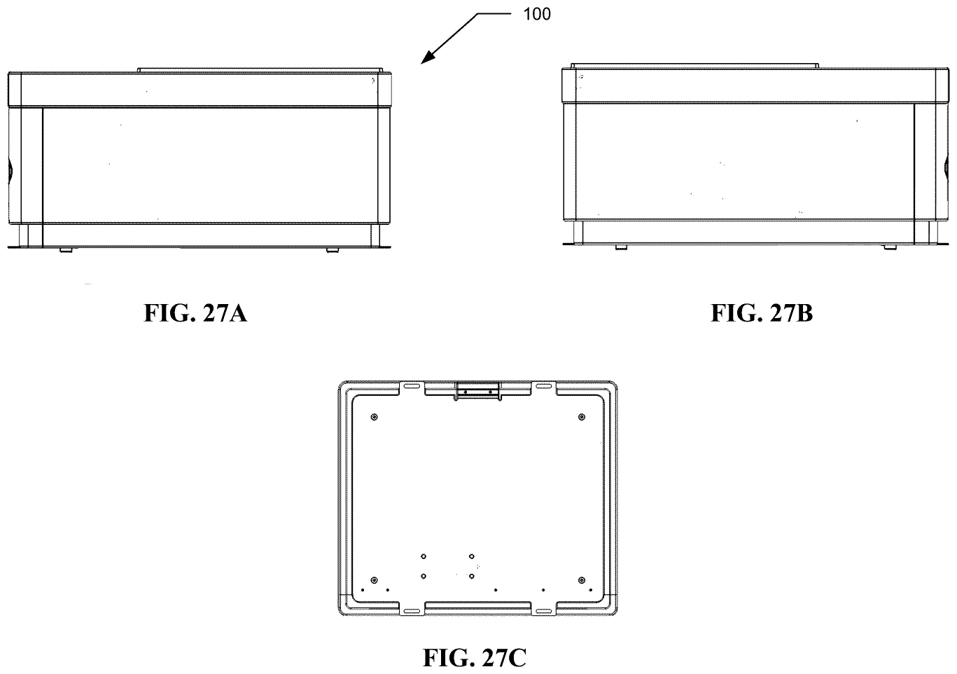

FIG. 27A shows a right side view of an example holding system 100.

FIG. 27B shows a left side view of an example holding system 100.

FIG. 27C shows a bottom view of an example holding system 100.

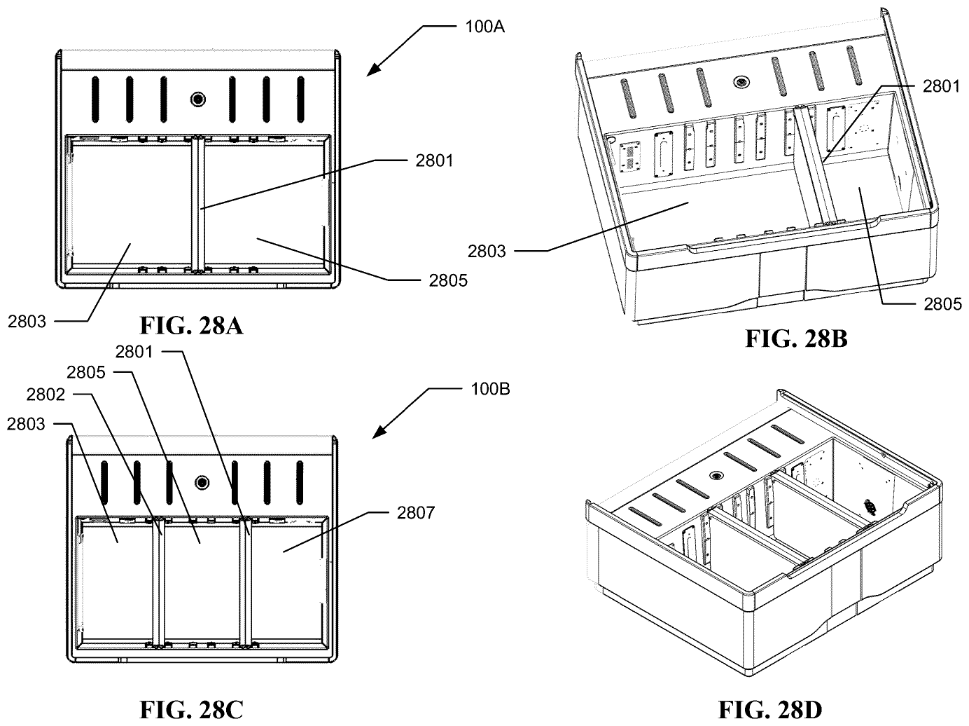

FIGS. 28A-B show various configurations of holding systems 100A demonstrating chamber compartmentalization capabilities. In some embodiments, a first divider 2801 is inserted to define a first chamber 2803 and a second chamber 2805 of varying dimensions within the holding system 100A. For example, in FIG. 28A, the first chamber 2803 and the second chamber 2805 are of equal dimension due to the first divider 2801 being centrally positioned within the basin. In FIG. 28B, the first divider 2801 may be reconfigured to increase the dimensions of the first chamber 2803 while reducing the dimensions of the second chamber 2805. In this manner, the delivery personnel may customize chamber sizes based on the specific requirements of different food orders or product types.

FIGS. 28C-D show configurations of holding systems 100B with multiple dividers. In some embodiments, the holding system 100B includes a first divider 2801 and a second divider 2802 that compartmentalize the basin into a first chamber 2803, a second chamber 2805, and a third chamber 2807. The dividers may be independently positioned to create chambers of varying dimensions based on specific delivery requirements. In some embodiments, the multiple divider configuration enables enhanced organization of food products requiring different environmental conditions within a single holding system.

While various aspects have been described, additional aspects, features, and methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

1. A food product holding system for vehicle-based delivery, comprising:
a basin configured to receive food products and comprising at least one mating surface;
the at least one mating surface configured to receive at least one engagement surface of at least one divider to segment the basin into at least a first chamber and a second chamber;
a door configured to transition between a first state and a second state to expose at least a portion of the basin; and
at least one environment regulation system configured to actively control at least one environmental condition within at least one of the chambers.

2. The food product holding system of claim 1, wherein:
the door is configured to slide horizontally from the first state to the second state to simultaneously expose all chambers of the basin.

3. The food product holding system of claim 1, wherein:
the at least one environment regulation system comprises a heating system configured to maintain a hot climate within the first chamber.

4. The food product holding system of claim 3, wherein:
the heating system comprises a positive temperature coefficient air heater.

5. The food product holding system of claim 1, wherein:
the at least one environment regulation system comprises a cooling system configured to maintain a cold climate within the second chamber.

6. The food product holding system of claim 5, wherein:
the cooling system comprises a compressor-based refrigeration module.

7. The food product holding system of claim 1, wherein:
the basin comprises a grated panel configured to provide a vertical offset between the food products and a bottom surface of the basin.

8. The food product holding system of claim 1, wherein:
at least one of the first chamber or the second chamber comprises at least one cupholder; and
the at least one cupholder is configured to transition between a stowed configuration and a deployed configuration.

9. The food product holding system of claim 1, wherein:
the basin comprises an external rail configured to receive at least one accessory module.

10. The food product holding system of claim 1, wherein:
the at least one mating surface comprises at least three mating surfaces spaced apart from another along the basin.

11. The food product holding system of claim 1, further comprising:
at least one attachment element configured to secure the basin to a vehicle.

12. The food product holding system of claim 11, wherein:
the food product holding system is configured to receive power from the vehicle.

13. A food product holding system for vehicle-based delivery, comprising:
a basin configured to receive food products and comprising a first channel, a second channel, and a third channel;
a first divider configured to be inserted into the first channel and a second divider configured to be inserted into the second channel to compartmentalize the basin into a first chamber, a second chamber, and a third chamber;
a door configured to transition between a closed state and an open state to expose at least a portion of the basin;
a heating system configured to maintain a hot climate within the first chamber;
a cooling system configured to maintain a cold climate within the third chamber; and
a humidity control system configured to control humidity levels within the second chamber.

14. The food product holding system of claim 13, wherein:
a portion of a bottom surface of the basin associated with the third chamber comprises an evaporator plate configured to transfer heat from the third chamber to a refrigerant of the cooling system.

15. The food product holding system of claim 13, wherein:
the humidity control system is configured to regulate airflows between the first chamber, second chamber, and third chamber to control humidity levels within the second chamber.

16. The food product holding system of claim 13, wherein:
the first divider and the second divider comprise at least one insulative material configured to minimize thermal transfer between chambers.

17. The food product holding system of claim 13, further comprising:
at least one subdivider configured to translate along a channel within the first chamber to segment the first chamber.

18. The food product holding system of claim 13, further comprising:
a first relative humidity and temperature sensor configured to measure temperature and humidity levels within the first chamber and a second relative humidity and temperature sensor configured to measure temperature and humidity levels within the third chamber.

19. The food product holding system of claim 18, further comprising:
a first display configured to render temperature and humidity measurements of the first chamber and a second display configured to render temperature and humidity measurements of the third chamber.

20. A method of maintaining food product quality during vehicle-based delivery, comprising:
inserting at least one divider into a basin to compartmentalize the basin into a plurality of chambers via interface of at least one engagement surface of the at least one divider with at least one mating surface of the basin;
placing hot-serve food products into a first chamber and cold-serve food products into a second chamber;
actively heating the first chamber to maintain the hot-serve food products within a target temperature range; and
actively cooling the second chamber to maintain the cold-serve food products within a target temperature range.
